(19) United States
(12) Patent Application Publication
(10) Pub. No.: US 2004/0179757 A1
(43) Pub. Date: Sep. 16, 2004

(54) Rubber material composition and linear motion apparatus

(75) Inventors: Toshikazu Yabe, Kanagawa (JP); Toshimi Takajo, Kanagawa (JP); Takahiko Uchiyama, Kanagawa (JP); Keisuke Yokoyama, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NSK LTD.

(21) Appl. No.: 10/804,142

(22) Filed: Mar. 19, 2004

Related U.S. Application Data
(63) Continuation of application No. 09/951,385, filed on Sep. 14, 2001.

(30) Foreign Application Priority Data
Sep. 14, 2000 (JP) P. 2000-279486
Nov. 14, 2000 (JP) P. 2000-346296
Mar. 5, 2001 (JP) P. 2001-060105
Apr. 3, 2001 (JP) P. 2001-105268

(51) Int. Cl. C08F 136/00

(52) U.S. Cl. 384/7; 524/827; 524/515; 526/317.1; 526/335; 526/341

(57) ABSTRACT

The present invention is to offer a rubber material composition excellent in an abrasion resistance and less to cause heat by friction, and is suitably used to sealing members of rolling devices to be used with grease lubrication under severe circumstances allowing water or dusts to much exist. The rubber material composition is fabricated with carboxylated acrylonitrile-butadiene rubber.

### BACKGROUND OF THE INVENTION

The present invention relates to a rubber material composition to be suitably used to sealing members furnished in rolling bearings (hub-unit bearings for automobiles, bearings for railway vehicles and others), linear guide apparatus, rolling devices of ball bearings, and in particular to a rubber material composition to be suitably used to sealing members of rolling devices served with grease lubrication under severe circumstances allowing much water or dusts to exist.

For elastic materials (contacting front ends (sealing lip portions) sliding with opposite materials as bearings) composing sealing members such as hub-unit seal, oil seal and the like, rubber material compositions have conventionally been used which are compounded with nitrile rubber, acrylic rubber or fluoro rubber added with additives, though the rolling apparatus having the sealing member is served under hard conditions as above mentioned. The sealing member employing the rubber material composition for the elastic member displays an enough sealing function also in the case of the grease lubrication under such circumstances of water or dusts being little, that is, clean circumstances.

However, being used outdoors, hub-unit bearings for automobiles or bearings for railway vehicles are exposed to much water (rain water or muddy water) and dusts, and the sealing member cannot probably keep enough lubrication, so that friction heat is generated between the contacting front end of the sealing member and a shaft to accelerate deterioration of grease or abrasion the contacting front end sliding with the shaft, and to cause inconveniences of invasion of the water or dust into the interior of the bearing, resulting in shortening a bearing life.

As one example of the sealing members to be furnished to the rolling apparatus used under severe environments as mentioned above, explanation will be made to the hub-unit seal for automobile hub-unit bearing.

Such a hub-unit seal is, for example, as shown in FIG. 1. The hub-unit seal 600 is composed of a core metal 605, a slinger 606 and an elastic member 607. In general, the elastic member 607 comprises a nitrile rubber composition.

The hub-unit seal 600 is very often used for long period under severe circumstances as exposed to muddy water. So, heat is generated between the slinger 606 and seal lips 614, 615, 616 of the elastic member 607, thereby to worsen the bearing grease and shorten the bearing life.

When the lubrication of the seal lips 614, 615, 616 becomes insufficient by being left to the water, their wearing is promoted to earlier decrease the sealing property, and in such a case or when the seal lips 614, 615, 616 become worn owing to using for long period, the water or dusts invade into the bearing to also reduce the bearing life.

In the conventional hub-unit seal 600 composing the elastic member 607 with the nitrile rubber composition, under the severely using conditions as above mentioned, the seal lips 614, 615, 616 of the elastic member 607 are easy to wear owing to sliding with the slinger 606 to decrease the sealing property therewith, so that the inherent function of the hub-unit seal is not fully exhibited.

Further, also before advancing of abrasion, the grease becomes poor by the friction heat, and similarly the function of the hub-unit seal is sometimes not fully exhibited.

On the other hand, although the bearings for rolling mills are used indoors, there much exist dusts of coke, iron ores, scales and others around the using environments, and said bearings are exposed to cooling water of numerous amount. The bearing using environments are worse than those of using bearings for railway vehicles or hub-unit bearings for automobiles. Accordingly, similar problems to the above probably arise.

As one example of the sealing members to be furnished to the rolling apparatus used under severe environments, explanation will be made to oil seals for railway vehicles.

Such an oil seal is, for example, an oil seal 601 with a garter spring as shown in FIG. 2. The oil seal 601 is furnished with a dust lip 604a, a main lip 604b, and the garter spring 606 disposed on the outer periphery of the main lip 604b, and is interposed between a shaft S and a seal case 602. Generally, a spring cover 603 is inserted under pressure and fixed between the seal case 602 and a fitting portion 605a of a metal ring 605.

The main lip 604b (elastic member) of the oil seal 601 is in general composed of a nitrile rubber composition, an acrylic rubber composition or a fluoro rubber composition.

The oil seal 601 as mentioned above is frequently and successively used in the bearings of railroad vehicles under the grease lubrication for long period. Therefore, the heat is caused between the shaft S and the main lip 604b sliding with the shaft S to worsen the bearing grease and shorten the bearing life.

When the lubrication of the main lip 604b becomes insufficient by being left to the water, its wearing is promoted to earlier decrease the sealing property, and in such a case or when the main lip 604b becomes worn owing to using for long period, the water or dusts invade into the bearing to also reduce the bearing life.

In the conventional oil seal 601 composing the main lip 604b (elastic member) with the nitrile rubber composition, acrylic rubber composition or fluoro rubber composition under the severely using conditions, the main lip 604b is easy to wear owing to sliding with the shaft S to decrease the sealing property therewith, so that the inherent function of the hub-unit seal is not fully exhibited. Further, also before advancing of abrasion, the grease becomes poor by the friction heat, and similarly the function of the oil seal is sometimes not fully exhibited.

Furthermore, as representatives of a linear guide apparatus generally used, there are a linear guide apparatus served as a linear-guiding apparatus or a ball screw served as a linear-driving apparatus.

The linear guide apparatus is known, for example, as shown in FIG. 10, provided with a guide rail 501 having grooves 503 for rolling elements at the outer sides axially extending and a slider 502 incorporated over the guide rail 501.

The slider 502 comprises a slider main body 502A and end caps 502B located at both ends in an axial direction thereof. The slider main body 502A has, inside of both sleeves 504, grooves (not shown) for rolling elements in opposition to the grooves 503 for rolling elements of the guide rail 501 as well as paths (not shown) for returning the rolling elements passing axially through a thick part of the sleeve 504. Thus, the grooves 503 for rolling elements of the guide rail 501 and the grooves for rolling elements of the slider main body 502A compose paths (not shown) for rolling element.

On the other hand, the end caps 502B have curved paths (not shown) for communicating the paths for rolling elements with the return paths for rolling elements parallel to said paths, and circulating paths of rolling elements are formed with said paths and the return paths at their both curved ends. The circulating paths of rolling elements are charged with lots of rolling elements made of, e.g., steel balls.

The slider 502 incorporated over the guide rails 501 smoothly moves along the guide rail 501 through rolling of the rolling elements within the paths for rolling elements, and during this removal, the rolling elements indefinitely circulate as rolling in the circulating paths within the slider 502.

The slider 502 is, as shown in FIG. 11, provided with side seals 505 (contacting seals of minus clearance to the guide rail 501 ) at both ends (edges of the respective end caps 502B) and an under seal 506 at an under surface as a dust proof seal device for sealing an opening of a gap between the slider 502 and the guide rail 501. These conventional seals are generally unified as one body with a rubber such as NBR (acrylonitrile-butadiene rubber) and a reinforcing member such as a steel sheet. By the way, numeral 507 in FIG. 10 designates a grease nipple.

On the other hand, being the ball screw as the linear-driving apparatus, though not shown, plastic seals are attached as the sealing member to both ends of ball screw nuts for preventing invasion of foreigners from an outside or diffusion of the inside lubricant to the outside. The ball screw has a structure for changing rotation of the screw shaft (or ball screw nut) into displacement in the axial direction of the ball screw nut (or screw shaft) via plural balls charged between spiral screw grooves formed in the outer periphery of the screw shaft and the spiral screw grooves formed in the inner periphery of the ball screw nut. The ball screw nut is attached at the end parts with the sealing member.

The sealing member is in general formed in ring shape with a resin material as polyacetal resin, has a convex in the inner periphery for fitting into the screw groove and has a notch (slit) cutting said ring in a diameter direction. The notch is opened to expand the ring and mount it on the screw shaft, followed by urging a seal attaching screw from the outer periphery at the end part of the ball screw nut, so that the sealing member is suppressed at the outer diameter surface toward an inside so as to fix it.

However, the existing linear guide apparatus or ball screw as mentioned above have been involved with respective problems as to the sealing members.

A problem of the linear guide apparatus will be explained. The grease filled in the slider 502 decrease as travelling of the slider 502 along the guide rail 501. Being accompanied therewith, a poor lubrication occurs between the lip parts of the side seals 505 and the guide rail 501, and these lip parts become gradually worn.

The sealing property goes down by such wearing progression, and foreigners as cut dusts go into the interior of the slider 502, and as cases may be, cause seizure of the linear guide apparatus itself.

The grooves 503 for rolling elements of the guide rail 501 are supplied with grease via the rolling elements in company with travelling of the sliders 502, so that portions of the lip parts contacting the grooves 503 for rolling elements are relatively less in wearing, while portions not supplied with grease via the rolling elements, for example, portions contacting the upper surface of the guide rail 501 are easy to cause the poor lubrication. As a result, if the lip part is fabricated with an ordinary nitrile rubber, the abrasion or breakage are caused there to decrease the sealing property, and similarly to the above mentioned, causing the seizure of the linear guide apparatus itself.

Next, a problem about the ball screw will be explained. Since the ring like sealing member is secured to the ball screw nut by stopper screws as mentioned above, a fitting clearance between the screw groove of the screw shaft and the convex of the sealing member depends on a dimensional relationship between the screw groove of the screw shaft and the sealing member. Therefore, the fitting clearance is not always zero (0), and depending on using conditions of the ball screw, the sealing property might be insufficient, as a result, foreigners as cut dusts are easy to go into the ball screw nut, causing the seizure of the linear guide apparatus itself.

### SUMMARY OF THE INVENTION

Accordingly, it is an object of the invention to offer such a rubber material composition having settled problems involved with the prior arts as mentioned above, excellent in abrasion resistance and less to cause heat by friction, and a rubber material composition to be suitably used to sealing members of rolling devices served with grease lubrication under severe circumstances allowing much water or dusts to exist.

For resolving the above mentioned problems, the invention has a composition as follows. That is, the rubber material composition of the invention is characterized by having a carboxylated acrylonitrile-butadiene rubber.

By this structure, being high in a cross-linking density, the rubber material composition has an excellent abrasion resistance and a bending-fatigue resistance. Thus, if composing, with the rubber material compositions of the invention, the sealing members of rolling devices served with grease lubrication under severe circumstances allowing much water or dusts to exist, it is possible to keep the excellent sealing property even under the severe circumstances, and impart an excellent life to the rolling device.

Further at this time for resolving the above mentioned problems, the invention has a further structure as follows. That is, the rubber material composition of the invention is preferably characterized by having 100 wt parts of carboxylated acrylonitrile-butadiene rubber and 20 to 90 wt parts of carbon black.

Further, it is an object of the invention to offer such a linear motion apparatus having settled problems involved with the prior arts as mentioned above, being excellent in the sealing property and long in life though used under circumstances allowing foreigners as cut dusts to easily invade, and to offer a rubber material composition to be suitably used to sealing members of the linear motion apparatus.

For resolving the above mentioned problems, the invention has a structure as follows. That is, the rubber material composition of the invention is characterized by having 100 wt parts of the carboxylated acrylonitrile-butadiene rubber and 10 to 60 wt parts of polyolefin.

Besides, the linear motion apparatus comprises an outer member, an inner member in opposite to the outer member via a clearance, a plurality of rolling elements rotatably supported between the outer member and the inner member for relatively moving the outer member and the inner member, and a contact sealing member for sealing the clearance, wherein the contact sealing member comprises the above mentioned rubber material composition and a reinforcing member for the rubber material composition.

By this structure, being excellent in the abrasion resistance and the bending-fatigue resistance, the rubber material composition composing the contact sealing member maintains a high sealing property and a long life though being used under circumstances allowing foreigners as machined dusts to easily invade.

The outer member mentioned above in the invention is meant by a slider if the linear motion apparatus is the linear guide apparatus, and it is meant by a ball screw nut in case of the ball screw, respectively. The inner member is meant by a guide rail if the linear motion apparatus is the linear guide apparatus, and by a screw shaft if it is the ball screw, respectively.

The reinforcing member employed in the linear motion apparatus of the invention is composed of metal or plastic, and is unified as one body with the rubber material composition for composing the contact sealing member. As far as imparting strength to the contact sealing member, shapes or structures thereof are not especially limited.

Further explanation will be made in detail to the rubber material composition of the invention.

The inventive rubber material composition has the carboxylated acrylonitrile-butadiene rubber as a raw rubber and a polyolefin based resin acting as an abrasion improving material (reinforcing material). This is, if needed, further added with several kinds of additives such as the reinforcing material, a vulcanization based additive, an age-register and a processing material, and suitably used as the material of the contact sealing member.

Reference will be made in detail to the rubber material composition of the invention.

The inventive rubber material composition has as the raw rubber carboxylated acrylonitrile-butadiene rubber (carboxyl modified nitrile rubber). This rubber material composition is suitably used as the material of the elastic member (the contacting front end (a sealing lip portion) sliding with the opposite material of the shaft) composing the sealing member to be furnished to tho rolling device. This may, if needed, further added with several kinds of additives such as the abrasion improving agent, the vulcanization based additive, a reinforcing filler(carbon black), an age resister, a lubricant, a lubrication oil and the processing material.

In addition, the carboxylated acrylonitrile-butadiene rubber has a structure of an ordinary acrylonitrile-butadiene rubber having carboxyl group. The cross-linking progresses in not only a double bond caused by butadiene but also in the rubber material composition by the carboxyl group, and as the cross-linking density goes up, the tensile strength of the rubber material composition improves than a case of using the ordinary acrylonitrile-butadiene rubber. As a result, the abrasion resistance and the bending-fatigue resistance improve.

Such a carboxylated acrylonitrile-butadiene rubber can be provided by, in addition of acrylonitrile and butadiene being ordinary monomers used by polymerization of acrylonitrile-butadiene rubber when producing by emulsion polymerization, further adding acrylic acid and methacrylic acid being monomers containing carboxyl group for making a copolymerization.

The addition amount of the monomer containing carboxyl group is 20 wt % or lower of all monomers, preferably 3 to 10 wt %. But, each monomer is not polymerized in accordance with the weight ratio of addition (that is, the weight ratio of the added monomer is different from a composition ratio of an obtained polymer), and since the monomers containing carboxyl group is difficult to polymerize, the composition ratio of the monomer containing carboxyl group in the obtained polymer is always lower than the weight ratio of addition.

The actual amount of carboxyl group in the obtained polymer is, in terms of an acid-equivalent weight, preferably 1×10⁻⁴ ephr or more, and more preferably 2×10⁻³ to 5×10⁻² ephr. If the acid-equivalent weight is less than 1×10⁻⁴ ephr, the cross-linking density is almost the same in comparison with acrylonitrile-butadiene rubber (not yet carboxylated), and accordingly the tensile strength and the abrasion resistance of rubber material composition are scarcely improved. For being less to cause such inconveniences, the acid-equivalent weight is preferably 2×10⁻³ ephr or more.

Being more than 5×10⁻² ephr, the amount of carboxyl group is too much and the cross-linking density is too high, and so a problems will occur around a later mentioned physical property of the rubber material composition. Specifically, a spring hardness might exceed 90, a tensile rupture elongation might be less than 200% and probability of scorching will be large.

In case the ordinary acrylonitrile-butadiene rubber is used as the raw rubber, when the tensile rupture elongation is around 200%, the tensile strength is around 15 to 20 MPa. In contract, in case the carboxylated acrylonitrile-butadiene rubber is used as the raw rubber, when the tensile rupture elongation is around 200%, the tensile strength is around 25 MPa or more.

This is assumed that since the cross-linking reaction progresses also in the part of carboxyl group in addition to the double bonding part caused by butadiene and the cross-linking density heightens, the tensile strength, the abrasion resistance and the bending-fatigue resistance improve in comparison with the case of using the ordinary acrylonitrile-butadiene rubber as the raw rubber. Therefore, if the sealing member used to the rolling element is fabricated at the contacting front end with such a rubber material composition, the contacting front end smoothly follows the rotation of the sealing member and scarcely receives damages. The acid-equivalent weight is a value measured as follows. Namely, a rubber is dissolved in acetone, re-precipitated and refined with n-hexane, followed by re-dissolving in pyridine, and this rubber solution is titrated as an indicator of thymolphthalein by use of ethanol solution of potassium hydroxide of 0.02N for making an equivalent weight to rubber 100 g.

The carboxylated acrylonitrile-butadiene rubber has several kinds as the ordinary acrylonitrile-butadiene rubber, and according to the containing amounts of acrylonitrile, there are in order the lower amounts, a low nitrile, a middle nitrile, a middle-high nitrile, a high nitrile, and an ultra high nitrile, and taking a heat resistance and an oil resistance into consideration, the middle nitrile, middle-high nitrile, high nitrile are desirable, and preferably 20 to 40% in terms of the amount of containing acrylonitrile.

If the rubber material composition is used to the sealing member as the hub unit seal, the vulcanization based additive and the age-register are added as necessary components, and as cases may be, several kinds of additives may be added as the reinforcing filler, the abrasion improving agent, the lubricant, the lubrication oil, and the processing material.

As the reinforcing filler, carbon black or white filler may be taken up. Specifically, there may be enumerated SAF (Super Abrasion Furnace black), ISAF (Intermediate Super Abrasion Furnace black), MAF (Medium Abrasion Furnace black), SRF (Semi-Reinforcing Furnace black), GPF (General Purpose Furnace black), FT (Fine Thermal Furnace black), MT (Medium Thermal Furnace black), HAF (High Abrasion Furnace black), and FEF (Fast Extruding Furnace black). For heightening the abrasion resistance, HAF, FEF, GPF and SRF having excellent reinforcing property and form-workability are desirable, and two kinds or more may be combined.

As the white filler, practically, taken up are hydrated silica, clay, talc, calcium carbonate, diatomaceous earth, wollastonite.

In case the carbon black is used as the reinforcing filler, an affinity with the carboxylated acrylonitrile-butadiene rubber is good and the reinforcing property is high, and so the abrasion resistance of the rubber material composition is good. Thus, abrasion at the contacting front end is restrained. Besides, by addition of the carbon black, a heat conductivity of the rubber material composition is made superior, heat generated by abrasion between the contacting front end and the opposite member is ready for diffusion. As the grease within the rolling device is hard to be deteriorated by heat, the life of the rolling device is lengthened.

Using such a reinforcing filler, improved is the abrasion resistance of the elastic member (the contacting front end (a sealing lip portion) sliding with the opposite material of the shaft) composing the sealing member, so that the sealing property between the elastic member and the opposite member is consequently heightened.

As to the addition amount of the reinforcing filler, in the case of carbon black, 20 to 90 wt parts are preferable for 100 wt parts of the carboxylated acrylonitrile-butadiene rubber. Being less than 20 wt parts, an enough reinforcing property does not appear, and being more than 90 wt parts, the hardness of the rubber material composition becomes high while the elongation goes down, and an inherent rubber elasticity decreases.

In the case of the white filler, 20 to 150 wt parts are preferable for 100 wt parts of the carboxylated acrylonitrile-butadiene rubber. Being less than 20 wt parts, the enough reinforcing property does not appear, and being more than 150 wt parts, the hardness of the rubber material composition becomes high while the elongation goes down, and the inherent rubber elasticity decreases.

To the carboxylated acrylonitrile-butadiene rubber, the vulcanization based additive and the age-register are added as necessary components, and as cases may be, the processing material, the abrasion improving agent, the lubrication oil, and the lubricant may be added.

Mixing the carbon black and the white filler, the mixture is preferably 20 to 200 wt parts for 100 wt parts of the carboxylated acrylonitrile-butadiene rubber. Of them, the carbon black is 10 to 90 wt parts, and the white filler is 10 to 110 wt parts. If the reinforcing filler is less than 20 wt parts, a sufficient reinforcing property dies not appear, and being more than 200 wt parts, the hardness of the rubber material composition becomes high while the elongation goes down, and the inherent rubber elasticity decreases.

Next, the abrasion improving agent will be referred to. As the abrasion improving agent, polyolefin particles or globular carbon particles are listed. The polyolefin particle is practically polyethylene-made or polypropylene-made particles, and more preferable are particles of the carboxylic modified polyethylene (maleic acid anhydride modified polyethylene) or carboxylic modified polypropylene (maleic acid anhydride modified polypropylene).

If polyethylene and polypropylene are carboxyl-modified, they are easily adsorbed to several kinds of rubbers or oxides by the carboxyl group in the structure. Since the carboxyl group existing in the carboxylated acrylonitrile-butadiene rubber being the raw rubber has the same effect as above mentioned, owing to a synergistic effect thereby, the mechanical strength such as the tensile strength, the abrasion resistance and the bending-fatigue resistance are assumed to be more improved.

The polyolefin based resin is added as the abrasion improving agent for improving the sliding property, and practically there are polyethylene or polypropylene, more preferably carboxylic modified (maleic acid anhydride modified) polyethylene or carboxylic modified (maleic acid anhydride modified) polypropylene. When polyethylene and polypropylene are carboxyl-modified, they are easily adsorbed (adhered) to several kinds of resins or oxides by the carboxyl group in the structure. When being added to the rubber, they are adsorbed to surface functional group as OH group existing in the surfaces of silica as the reinforcing agent or oxides of zinc oxide as the vulcanization accelerating agent, and they are compounded with particles thereof, and work as more effective abrasion improving agents.

Since the carboxyl group of the carboxylated acrylonitrile-butadiene rubber being the raw rubber has a property adsorbing to the surface functional group as OH similarly to the above, forming the compounded condition as above, the mechanical strength of the rubber material composition such as the tensile strength, the abrasion resistance and the bending-fatigue resistance are assumed to be more improved.

The addition amount of the polyolefin based resin is preferably 10 to 60 wt parts for 100 wt parts of the carboxylated acrylonitrile-butadiene rubber from the viewpoint of balance with the abrasion resistance and the physical property of the rubber material composition.

If the addition amount of tho polyolefin based resin is less than 10 wt parts for 100 wt parts of the carboxylated acrylonitrile-butadiene rubber, the improving effect of the abrasion resistance is low. Reversely, being more than 60 wt parts, the hardness of the rubber material composition is high, the elongation is low and the rubber elasticity goes down, and if used as the contact sealing member of the linear guide apparatus, inconvenience as under mentioned will be assumed.

Explanation will be made to, for example, the case that the linear motion apparatus is the linear guide apparatus. In the linear guide apparatus, the lip part of the contact sealing member is deformed owing to the linear reciprocation of the slider, and by this deformation, the clearance between the slider and the guiding rail is maintained 0 or lower. However, if the rubber elasticity of the lip part is low, the deformation of the lip part is difficult to follow the movement of the slider, so that the clearance appear intermittently between the lip part and the guide rail. Then, foreigners gradually go into the interior of the slider main body through the clearance, and finally the slider is probably caused with seizure.

The addition amount of the polyolefin particles is preferably 10 to 60 wt parts for 100 wt parts of the carboxylated acrylonitrile-butadiene rubber from the viewpoint of balance with the abrasion resistance and tho physical property of the rubber material composition. If the addition amount of the polyolefin particles is less than 10 wt parts for 100 wt parts of the carboxylated acrylonitrile-butadiene rubber, the improving effect of the abrasion resistance is low. Reversely, being more than 60 wt parts, the hardness of the rubber material composition is high, the elongation is low and the rubber elasticity goes down.

Further, the globular carbon particle (vitrified carbon, globular graphite) is formed in that phenol formaldehyde resin is carbonized and baked in nitrogen at temperatures of 800 to 2000° C., and the average grain size is around 2 to 40 μm. Practically, Bel-Pearl C (registered trade mark) of Ranebo Co., Ltd. is desirable.

When such globular carbon particles exist on the surface of the rubber material composition, the globular carbon particles receive load, so that the abrasion resistance of the rubber material composition is largely improved. The mixing ratio of the globular carbon particles is not especially limited, but desirably 5 to 40 wt parts for 100 wt parts of the carboxylated acrylonitrile-butadiene rubber.

The lubricant for heightening lubrication will be explained. As the lubricant, a wax (oil and fatty of low melting point) of a melting point being 40 to 140° C. is listed. Actually, falling into the above range of the melting point, there are paraffin wax, micro-crystal wax, polyethylene wax, montan wax, carnauba wax, ester based wax, stearamide, oxystero amide, erucylamide, laurylamide, palmitylamide, behenamide, methylolamide, ethylenebisoleylamide, stearyloleylamide. Among them, the polyethylene wax is most desirable. If these lubricants are added 3 to 30 wt parts for 100 wt parts of the carboxylated acrylonitrile-butadiene rubber, the lubrication of the rubber material composition goes up. Being less than 3 parts, the sufficient lubrication cannot be provided, and being more than 30 wt parts, not only the sufficient tensile strength and elongation cannot be obtained and the rubber elasticity goes down, but also the adherence between the core metal and the elastic member composing the sealing member is extremely decreased.

As the lubricant oil, there are enumerated a mineral oil, an ether based oil, a silicone based oil, a poly α olefin oil, a fluorine oil, and a fluorine based surfactant. Among them, the silicone based oil is preferable. The silicone oil is a liquid substance at room temperature having a main component of polydimethyl siloxane, and for increasing an affinity with the carboxylated acrylonitrile-butadiene rubber, it is preferable that a part of the methyl group of the polydimethyl siloxane or molecular terminal is a modified type replaced with amino group, alkyl group, polyether group, higher fatty acid ester. By modifying with such functional groups, the functional group reacts with or adsorbs to a main chain the carboxylated acrylonitrile-butadiene rubber to prevent the oil from blooming at once on the surface of the rubber composition and at the same time to allow to bloom gradually and permanently. As a result, the oil is supplied to the surface of the rubber composition permanently.

Since the lubricant oil is liquid and easy to bloom on the surface of the rubber material composition, the lubricating effect is displayed with an addition smaller than that of the lubricant. If such a lubricant oil is added 1 to 30 wt parts for 100 wt parts of the carboxylated acrylonitrile-butadiene rubber, the lubricity of the rubber material composition is improved. Being less than 1 wt part, the sufficient lubricity is not provided, while being more than 30 wt parts, a poor dispersion of the additive easily occurs during processing the rubber material composition.

Explanation will be made to the reinforcing material, the vulcanization based additive and the age resister to be added together with the polyolefin to the carboxylated acrylonitrile-butadiene rubber.

The reinforcing material has an effect improving, in particular, the mechanical strength among the properties of the rubber material composition as well as an effect improving the abrasion resistance. Actually, available are globular or indefinite particles such as silica, clay, basic calcium carbonate, magnesium silicate, carbon black, or fibrous forms such as amide fiber (aromatic polyamide fiber) as potassium titanate whisker, polym-phenylene isophthalamido shown in the under chemical formula 1 or poly p-phenylene isophthalamido shown in the under chemical formula 2.

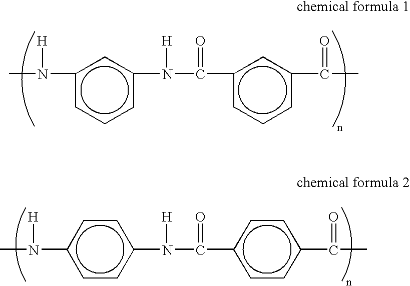

If these reinforcing materials, in particular, the reinforcing materials of oxide group such as silica are further added with a coupling agent as silane coupling agent having a functional group as amino group or a mercapto group at one terminal and having hydrolyzing group (actually, alkoxy group as methoxy group) at another terminal, an interaction (false combination one another) of the raw rubber—the coupling agent—the reinforcing material is strengthened, and the reinforcing effect is preferably heightened. The addition amount of the reinforcing material is so adjusted that the rubber material composition has the above mentioned mechanical strength.

The vulcanization based additives will be explained. As the vulcanization based additives, there are a vulcanizing agent (cross-linking agent), a vulcanization accelerator, and a vulcanization accelerating assistant.

As the vulcanizing agent (cross-linking agent), listed are several kinds of sulfurs such as powder sulfur, flower of sulfur, precipitated sulfur, high dispersion sulfur; sulfur compounds enabling to generate sulfurs as morpholinedisulfide, alkylphenoldisulfide, N,N-dithiobis (hexahydro-2H-azepinon-2), thiurampolysulfide; and peroxides such as dicumyl peroxide, di (t-butylperoxide) diisopropylbenzen, 2, 5-dimethyl-2, 5-di (benzoylperoxy) hexan, benzoylperoxide. Among them, from viewpoint of the dispersion, the easy management, and the heat resistant, it is desirable to use the high dispersion sulfur and morpholinedisulfide.

For using the sulfur based vulcanizing agent, it is necessary to use the vulcanization accelerators such as guanidine based, aldehyde-ammonia based, thixzole based, sulfeneamide based, thiourea based, thiuram based, dithiocarbamate based, zantate based accelerators. Among them, if compounding a bit the high dispersion sulfur, it is desirable to cooperate with thiuram based tetramethylthiuram disulfide, sulfeneamide based N-cyclohexyl-2-benzothiazyl sulfenamide, and thiazole based 2-mercaptobenzothiazol.

As the vulcanization accelerating assistant, there are metallic oxides as zinc oxide, metallic carbonate, metallic hydroxide, fatty acid as stearic acid and derivatives thereof and amines. Since the carboxylated acrylonitrile-butadiene rubber is easy to earlier generate the vulcanization by zinc oxide, a combination of zinc peroxide and stearic acid is preferable. The zinc peroxide exists as it is in the rubber material composition until temperature of kneading and processing the rubber material composition, and generates the zinc oxide when vulcanization-forming, and therefore it does not cause an early vulcanization when kneading and processing and when maintaining.

The age resister avoiding oxidizing deterioration will be referred to. As the age resister, enumerated are amine keton condensation product, aromatic secondary amines, monophenol deviate, bis or polyphenol deviate, hydroquinone deviate, sulfur based age resister, phosphorus based age resister; and a wax such as micro-cryrtalline wax. Among them, especially preferable are amine keton condensation product based 2, 2, 4-trimetyl-1, 2-dihydroquinon copolymer, condensation product of diphenylamine and acetone, aromatic secondary amine based N,N′-di-β-naphthyl-p-phenylenediamine, 4,4′-bis (α, α-dimethylbenzil) diphenylamine, N-phenyl-N′-(3-methacryloyloxy-2-hydroxylpropyl)-p-phenylenediamine.

For avoiding heat decomposition and improving the heat resistance, it is more preferable to cooperate a secondary age resister together with the above age resister. The secondary age resister is sulfur based 2-mercaptobenzimidazole, 2-mercaptomethylbenzimidazole, and zinc salts thereof.

As sun-crack preventing agent restraining formation of cracks by the sunlight or ozone, waxes of the melting point being 55 to 70° C. may be added 0.5 to 2 wt parts for 100 wt parts of the carboxylated acrylonitrile-butadiene rubber. Being less than 0.5 wt parts, an effect of preventing ozone cracks is hardly obtained, while being more than 2 wt parts, a problem will occur about the workability since unnecessary waxes bloom on the surface of the rubber material composition.

If a formability should be heightened, a plasticizer as a processing aid is added other than the above additives. Being no matter about the forming, no additives are required. When adding the plasticizer, it is sufficient to add 3 to 20 wt parts for 100 wt parts of the carboxylated acrylonitrile-butadiene rubber, and if the addition is more than a necessary amount, the rubber material composition is softened and at the same time the plasticizer is not completely mixed and might bleed out.

Actual examples of the plasticizer are phthalic acid diester as dioctyl phthalate, polyester based plasticizer, polyetherester based plasticizer, and liquid nitrile rubber.

For heightening the abrasion resistance, it is desirable to add globular or particulate carbon particles (vitrified carbon, globular graphite) of average size being around 10 to 20 μm of 5 to 20 wt parts for 100 wt parts of the raw rubber.

As the carbon particles, Bel-Pearl C ( registered trade mark) is known, and this is isotropic carbon formed in that phenol formaldehyde resin is carbonized and baked in nitrogen at temperatures of 800 to 2000° C. The carbon particle has a larger particle size than that of the ordinary carbon black, and it is not aggregated but uniformly dispersed. Further, if this carbon particle exists on the surface of the rubber material composition, it effectively receives load, so that the abrasion resistance is largely increased.

The rubber material composition is ordinarily added with waxes)of the melting point being 55 to 70° C. 0.5 to 2 wt parts for 100 wt parts of the raw rubber as the age resister, practically the sun-crack preventing agent restraining formation of cracks by the sunlight or the ozone.

Other than the waxes for aging prevention, if waxes of the melting point ranging 75 to 130° C. or fatty acid amide is added 5 to 20 wt parts for 100 wt parts of the raw rubber, the lubricity on the surface of the rubber material composition is preferably improved.

The improvement of the lubricity is brought about in that the added waxes or the fatty acid amide bloom on the surface of the rubber material composition, and by the sliding heat effected by the linear guide apparatus working, more waxes or fatty acid amide bleed out on the surface, and the effect thereby is larger.

As actual examples of the waxes to be added to increase the lubricity falling in the above melting points, there are paraffin based compound wax, polyethylene wax, montan wax, carnauba wax, ester based wax. As the fatty acid amide, there are stearamide, oxysteroamide, erucylamide, laurylamide, palmitylamide, behenamide, methylolamide, ethylenebisoleyl amide, stearyloleylamide.

In the rolling elements furnished with the contact sealing member employing the rubber material composition of the invention, a lubricant supply member comprising a lubricant-containing polymer may be disposed nearly the contact sealing member If the lubricant is supplied from the lubricant supply member to the contact sealing member, lubrication around the sliding parts thereof is made good and the sliding parts are difficult to be worn, so that the high sealing property is maintained for a longer period and the life of the linear guide apparatus is more lengthened.

Detailed explanation will be made to materials of the lubricant-containing polymer composing the lubricant supply member.

The lubricant-containing polymer is provided in that the lubricant is mixed in at least one kind selected from a group of the polyolefin based resins having basically the same chemical structure as polyethylene, polypropylene, poly butylene, or polymethylpenten, this mixture is heated higher than a melting point of the polyolefin based resin, and cooled into solidification. As far as hating necessary properties as materials of the lubricant-containing polymer such as a capacity of containing the lubricant (described as “oil holding capacity” hereafter), other resins are available.

As the lubricant, taken up are a paraffin based hydro carbon as poly α-olefin, mineral oil, an ether oils like dialkyl diphenyl ether, and an ester oil like phthalic acid ester, and they may be used solely or in combination. Further, such lubricants may be used which are in advance added with additives of anti-oxidant, rust inhibitor, abrasion inhibitor, anti-foamer, or extreme pressure additives.

A composing ratio of the polyolefin based resin and the lubricant in the lubricant-containing polymer is preferable in that, with respect to all weights, the polyolefin based resin is 10 to 50 wt % and the lubricant is 90 to 50 wt%. If the polyolefin based resin is less than 10 wt%, the hardness and strength of the lubricant-containing polymer are not sufficient and possibility of inconveniences as breakage will be high when load is effected by action of the linear guide apparatus. If the polyolefin based resin is more than 50 wt% (that is, the lubricant is less than 50 wt %), the lubricant is less supplied to the sliding parts (lip parts) and the abrasion around the sliding parts is accordingly less reduced.

Ordinarily, there are some of resins have various average molecular weights (basic structures are similar, and average molecular weights are 700 to 5×10⁶), and properties of matter thereof are often varied owing to the average molecular weight. Thus, if required, resins of various average molecular weights are mixed to adjust resins having desired properties of matter.

For example, in the case of the polyolefin based resins, there are those classified into waxes of the average molecular weights of 700 to 1×10⁴ (for example, polyethylene wax), others having comparatively low average molecular weights of 1×10⁴ to 1×10⁶, and some having ultra high molecular weights of the average molecular weights of 1×10⁶ to 5×10⁶.

By the combination of the polyolefin based resins having the comparatively low molecular weights and the lubricant, a lubricant-containing polymer having a mechanical strength, a lubricant supplying capacity and an oil holding capacity of certain degrees is provided. If substituting the polyolefin based resins classified into waxes for parts of those having the comparatively low molecular weights, since a difference in the molecular weight between those classified into waxes and the lubricant is small, an affinity with the lubricant is heightened, and the lubricant can be supplied for a longer period. However, reversely the mechanical strength is lowered. By the way, as the wax, other than the polyolefin based resin like the polyethylene, hydrocarbon based waxes having melting points ranging higher than 100 to 130° C. (for example, paraffin based composite waxes) are also used.

On the other hand, if substituting the polyolefin based resins of the ultra high molecular weight for parts of those having the comparatively low molecular weights, since a difference in the molecular weight between those the ultra high molecular weight having and the lubricant is large, the affinity with the lubricant is lowered, and accordingly the oil holding capacity goes down. As a result, an effect adjusting the lubricant exuding from the lubricant-containing polymer trends to decrease (the lubricant exudes rapidly). Thereby, a short time is taken for reaching an amount of the lubricant enabling to supply from the lubricant-containing polymer, so that the life of the linear guide apparatus is shortened. But the mechanical strength is increased.

Taking a balance of the formability, the mechanical strength, the oil holding capacity and the lubricant supplying amount into consideration, it is preferable a composing ratio of the lubricant-containing polymer is preferable in that those classified into waxes are 0 to 5 wt %, those having the comparatively low average molecular weights are 8 to 48 wt %, those having the ultra high molecular weight 2 to 15 wt %, and these three kinds are 10 to 50 wt % in total (the rest being the lubricant).

Incidentally, it is sufficient to compose the lubricant supply member with such a lubricant-containing polymer added with additives in ranges not spoiling the objects of the invention.

For example, for improving the mechanical strength of the lubricant-containing polymer, it is sufficient to add thermoplastic resins or thermosetting resins as mentioned under to the above mentioned polyolefin based resin.

As the thermoplastic resins, there are listed, for example, polyamido, polycarbonate, polybutyleneterephthalate, polyphenylene sulfide, polyether sulfon, polyetherether keton, polyamido imido, polystyrene, or ABS resin.

As the thermosetting resins, there are listed, for example, unsaturated polyester resin, urea resin, melamine resin, phenol resin, polyimido resin, or epoxy resin.

These thermoplastic and thermosetting resins may be mixed solely or in combination.

In addition, for more uniformly dispersing the poly olefin based resins and other resins may be added with proper solvents.

For heightening the mechanical strength, fillers may be added. For example, enumerated are calcium carbonate, magnesium carbonate, inorganic whiskers as potassium titanate whisker or aluminum borate whister, those fabricated in fabric or in cloth with inorganic fiber of glass fiber or metallic fiber, carbon black powder, carbon fiber, aramido fabric, or polyester fabric.

For a purpose of avoiding deterioration by the heat of the polyolefin based resin, the age resisters may be added such as N,N′-diphenyl-p-phenylenediamine, 2,2′-methylene bis (4-ethyl-6-t-butylphenol), and for a purpose of avoiding deterioration by the light, ultraviolet absorbents may be added 6 such as 2-hydrox-4-n-octoxibenzophenon, or 2-(2′-hydrox-3′-t-butyl-5′-methylphenyl)-5-chlorobenzotriazole.

As to the addition amount of all the above additives (other than the polyolefin based resin and the lubricant), 20 wt % or lower of the whole is desirable for maintaining the supplying capacity of the lubricant supply member.

Next reference will be made to the properties of matter. The hardness of the rubber material composition is given influences by the addition amounts of the reinforcing filler or the abrasion improving agent, and from the viewpoint of a sealing property and a following property when applying to the sealing member of the rolling bearings for vehicles, the hardness of the rubber material composition is preferably 60 to 90 in the spring hardness A scale set forth in JIS K6301.

If the hardness is less than 60, the contacting front end is deformed more than necessarily when the sealing member starts rotation. As a result, the abrasion resistance is large when the rolling element is driven, and a smooth rotation is difficult. Being more than 90, the rubber elasticity decreases as mentioned above, and the sealing property and the following property of the contacting front end go down at rotation movement. If using under an environment of much dusts, the life of the rolling element is probably lowered.

For decreasing the deformation degree of the contacting front and and making the properties such as the rubber elasticity especially desirable, the spring hardness of the rubber material composition is particularly preferable 70 to 80.

The hardness of the rubber material composition is influenced by the addition amount of the polyolefin based resin, and from the viewpoint of the sealing property or the following property to deformation when applying the rubber material composition to the contact sealing member, the spring hardness measured by a durometer A scale is preferably 60 to 90.

If the spring hardness is less than 60, when the moving side member (in the linear guide apparatus, it is the slider, and in the ball screw, it is the ball nut screw) of the linear guide apparatus makes the linear reciprocation, since the lip parts of the contact sealing member accompanied therewith are more deformed than necessarily, the friction resistance is consequently large, and the friction force is large when moving, and the reciprocation is not smooth.

If the spring hardness is more than 90, the rubber elasticity goes up as mentioned above, and the following property of the lip part during reciprocation, in short, the sealing property is inferior, and if using under circumstances of much foreigners, the life of the rubber material composition is shortened.

For making the deformation degree of the lip part or the performance such as the rubber elasticity particularly preferable, the spring hardness of the rubber material composition is particularly preferable 70 to 80.

Further, for causing the deformation of the lip part to rapidly follow the reciprocation and making the lip part difficult to bring damages, the rubber material composition has the hardness as mentioned above, and is necessary to have the mechanical strengths that the tensile rupture elongation is 200% or higher, preferably 300% or higher, and the tension rupture strength is 20 MPa or more, preferably 25 MPa or more.

When using the ordinary acrylonitrile-butadiene rubber as the raw rubber, and if trying to maintain the tensile rupture elongation 200% or higher, the tension rupture strength is 15 to 20 MPa at the most, and the high tension rupture strength as mentioned above is a large characteristic when using as the raw rubber the carboxylated acrylonitrile-butadiene rubber. In addition having the interaction with the reinforcing material as above mentioned, the carboxylated acrylonitrile-butadiene rubber has not only the double combined part caused by butadiene but also properties of improving the tensile strength, the abrasion resistance and the bending-fatigue resistance by progressing the cross-linking also in the carboxyl group and heightening the vulcanizing density.

### BRIEF DESCRIPTION OF THE DRAWINGS

FIG. 1 is a partially and vertically cross sectional view showing the structure of the oil seal composed of the rubber material composition of the prior art;

FIG. 2 is a vertically cross sectional view showing the structure of the hub unit seal composed of the rubber material composition of the prior art;

FIG. 3 is a perspective view of the linear guide apparatus furnished with the contact sealing member composed of the rubber material composition of the invention;

FIG. 4 is a partially enlarged view showing shapes of the lip parts of the contact sealing member of the linear guide apparatus of FIG. 3;

FIG. 5 is a perspective view showing attaching states of respective parts at edge parts of another linear guide apparatus furnished with the contact sealing member composed of the rubber material composition of the invention;

FIG. 6 is a side view of the ball screw furnished with the contact sealing member composed of the rubber material composition of the invention;

FIG. 7 is a front view of the ball screw of FIG. 6;

FIG. 8 is a view showing contacting parts of a thread groove of the ball screw of FIG. 6 and the contact sealing member;

FIG. 9 is an enlarged view showing a state of the contact sealing member contacting the thread groove of the screw shaft;

FIG. 10 is a perspective view of a conventional linear guide apparatus; and

FIG. 11 is a perspective view showing the under side of the linear guide apparatus of FIG. 10.

### DESCRIPTION OF THE PREFERRED EMBODIMENT

Embodiments of the rubber material compositions of the invention will be explained with reference to the attached drawings.

The presently embodied rubber material compositions were produced by mixing the raw rubbers, the reinforcing fillers, and the additives at ratios shown in Tables 1 and 2 through the following respective steps.

TABLE 1

| | Example 1 | Example 2 | Example 3 | Example 4 | Example 5 | Example 6 |
|---|---|---|---|---|---|---|
| Raw rubber A | 100 | 100 | 100 | 100 | 100 | 100 |
| Raw rubber B | | | | | | |
| Carbon black | 50.0 | 50.0 | 50.0 | | | |
| Silica | | | | 50.0 | SO.O | 50.0 |
| Clay | | | | | | |
| vulcanizing agent | 0.5 | 0.5 | 0.5 | 0.5 | 0.5 | 0.5 |
| Vulcanization | 0.8 | 0.8 | 0.8 | 0.8 | 0.8 | 0.8 |
| accelerator A | | | | | | |
| Vulcanization | 1.5 | 1.5 | 1.5 | 1.5 | 1.5 | 1.5 |
| accelerator B | | | | | | |
| Vulcanization | 1.0 | 1.0 | 1.0 | 1.0 | 1.0 | 1.0 |
| accelerator C | | | | | | |
| Vulcanization | 1.0 | 1.0 | 1.0 | 1.0 | 1.0 | 1.0 |
| accelerating | | | | | | |
| assistant A | | | | | | |
| vulcanization | | | | | | |
| accelerating | | | | | | |
| assistant B | | | | | | |
| Vulcanization | 5.0 | 5.0 | 5.0 | 5.0 | 5.0 | 5.0 |
| accelerating | | | | | | |
| assistant C | | | | | | |
| Activator | | | | | | |
| Plasticizer | 5.0 | 5.0 | 5.0 | 5.0 | 5.0 | 6.0 |
| Abrasion | 20.0 | | | | 20.0 | |
| improving agent A | | | | | | |
| Abrasion | | 20.0 | | | | |
| improving agent B | | | | | | |
| Age resister A | 1.0 | 1.0 | 1.0 | 1.0 | 1.0 | 1.0 |
| Age resister B | 1.0 | 1.0 | 1.0 | 1.0 | 1.0 | 1.0 |
| Age resistor C | 1.0 | 1.0 | 1.0 | 1.0 | 1.0 | 1.0 |
| Lubricant oil | | | 5.0 | | | 5.0 |
| Coupling agent | | | | 2.0 | 2.0 | 2.0 |

Unit: parts by weight

TABLE 2

| | | | Comparative | Comparative | Comparative |
|---|---|---|---|---|---|
| | Example 7 | Example 8 | example 1 | example 2 | example 3 |
| Raw rubber A | 100 | 100 | | | |
| Raw rubber B | | | 100 | 100 | 100 |
| Carbon black | | 50.0 | 50.0 | | |
| Silica | | | | 50.0 | 50.0 |
| Clay | 120 | 40.0 | | | |
| Vulcanizing agent | 0.5 | 0.5 | 0.5 | 0.5 | 0.5 |
| Vulcanization | 0.8 | 0.8 | 0.8 | 0.8 | 0.8 |
| accelerator A | | | | | |
| Vulcanization | 1.5 | 1.5 | 1.5 | 1.5 | 1.5 |
| accelerator B | | | | | |
| Vulcanization | 1.0 | 1.0 | 1.0 | 1.0 | 1.0 |
| accelerator c | | | | | |
| Vulcanization | 1.0 | 1.0 | 1.0 | 1-0 | 1.0 |
| accelerating | | | | | |
| assistant A | | | | | |
| Vulcanization | | | 5.0 | 5.0 | 5.0 |
| accelerating | | | | | |
| assistant B | | | | | |
| Vulcanization | 5.0 | 5.0 | | | |
| accelerating | | | | | |
| assistant C | | | | | |
| Activator | | | | 2.0 | 2.0 |
| Plasticizer | 5.0 | 5.0 | 5.0 | 5.0 | 5.0 |
| Abrasion improving | | | | | |
| agent A | | | | | |
| Abrasion Improving | | | | | |
| agent B | | | | | |
| Age resister A | 1.0 | 1-0 | 1.0 | 1.0 | 1.0 |
| Age resister B | 1.0 | 1.0 | 1.0 | 1.0 | 1.0 |
| Age resistor C | 1.0 | 1.0 | 1.0 | 1.0 | 1.0 |
| Lubricant oil | | | | | 5.0 |
| Coupling agent | | | | 2.0 | 2.0 |

Unit: parts by weight

Firstly, explanation will be made to the respectively used materials (described in Tables 1 and 2).

Raw rubber A: carboxylated middle high nitrile rubber (Nipol DN631 made by Nippon Zeon Co., Ltd.), the ratio of the sole acrylonitrile: 33.5%

Raw rubber B: middle high nitrile rubber (JSR NBR N230S made by JSR Co., Ltd.), the ratio of the sole acrylo nitrile: 35%

Carbon black (reinforcing filler): carbon black HAF (Dia Black H made by Mitsubishi Chemicals Co., Ltd.)

Silica (white filler): hydrated silica (Nip Seal AQ made by Nippon Silica Industries Co., Ltd.)

Clay (white filler): kaolin clay (ST-309 made by Shiraishi Calcium Co., Ltd.)

Vulcanizing agent: high dispersing sulfur (Sulfax PMC made by Tsurumi Industries Co., Ltd.)

Vulcanization accelerator A: tetramethylthiuramdi sulfide (Accel TMT made by Kawaguchi Chemical Industries Co., Ltd.)

Vulcanization accelerator B: tetraethylthiuramdi sulfide (KOCCELLER TET made by Ohuchi Shinko Chemical Industries Co., Ltd.)

Vulcanization accelerator C: N-cyclohexyl-2-benzo thiazil-sulfenamido (Accel CZ-R made by Kawaguchi Chemical Industries Co., Ltd.)

Vulcanization accelerating assistant A (serving also the lubricant): stearic acid (Lunac S-35 made by Kao Co., Ltd.)

Vulcanization accelerating assistant B: zinc oxide (France No. 1 made by Sakai Chemical Co., Ltd.)

Vulcanization accelerating assistant C: zinc oxide (Zeonet Zp made by Nippon Zeon Co., Ltd.), added by the master batch process

Activator: organic amine (Acting SL made by Yoshitomi Seiyaku Co., Ld.)

Plasticizer; dioctyl phthalate (DOP made by Daihachi Chemicals Co., Ltd.)

Abrasion improving agent A: carboxyl modified polyethylene particle (Modic-AP H501 made by Mitsubishi Chemicals Co., Ltd.)

Abrasion improving agent B: carboxyl modified polypropylene particle (Hodic-AP H502 made by Mitsubishi Chemicals Co., Ltd.)

Age resister A: 4,4′-bis (α, α-dimethylbenzil) diphenylamine (NOCRAC CD made by Ohuchi Shinko Chemical Industries Co., Ltd.)

Age resister B; 2-mercaptobenzimidazole NOCRAC MB made by Ohuchi Shinko Chemical Industries Co., Ltd.)

Age resister C: special wax (SUNNOC made by Ohuchi Shinko Chemical Industries Co., Ltd.)

Lubricant: Amino-modified silicone oil (KF-860 made by Shinetsu Silicone Co., Ltd.)

Coupling agent: γ mercaptopropyltrimethoxysilane KBM803 made by Shinetsu Silicone Co., Ltd.)

Next, reference will be made to respective steps for producing the rubber material composition.

(1) First Kneading Step

Materials other than the vulcanizing agents and the vulcanization accelerators of Tables 1 and 2 were charged into a banbury mixer, and kneaded at 80° C.

(2) Second Kneading Step

The kneaded material was take out from the banbury mixer, and charged into a rubber kneading two-roll. As controlling the roll temperature at 50° C., the vulcanizing agents and the vulcanization accelerators of Tables 1 and 2 were charged and the operation was repeated until becoming uniform, followed by forming a sheet shape.

(3) Vulcanizing Step

A hot press heated at 170° C. was attached with a sheet vulcanizing mold for making 2mm thickness on which the sheet obtained in the second kneading step was mounted. The sheet was heated and pressed for 15 minutes, and the vulcanized rubber sheets of 150 mm×150 mm×2 mm were produced.

The thus produced rubber material compositions (Examples 1 to 8 and Comparative examples 1 to 3) were performed with the hardness test and the tensile test. The respective testing methods are as follows.

(a) Hardness Test

The sheet obtained in the vulcanizing step was stamped into shape of JIS No.3 test piece, and piled in three sheets for measuring hardness (spring hardness A scale) based on JIS K6301.

(b) Tensile Test

JIS No.3 test piece was performed with the tensile test by means of a universal tester for measuring the tension rupture strength and the tension rupture elongation.

These tested results are shown in Tables 3 and 4.

TABLE 3

| | Example 1 | Example 2 | Example 3 | Example 4 | Example 5 | Example 6 |
|---|---|---|---|---|---|---|
| Hardness | 81 | 83 | 78 | 82 | 84 | 83 |
| Tension rupture | 28.1 | 30.2 | 27.5 | 25.8 | 26.2 | 26.0 |
| strength¹⁾ | | | | | | |
| Tension rupture | 312 | 302 | 240 | 340 | 329 | 362 |
| elongation²⁾ | | | | | | |

¹⁾Unit: Mpa
²⁾Unit: %

TABLE 4

| | | | Comparative | Comparative | Comparative |
|---|---|---|---|---|---|
| | Example 7 | Example 8 | example 1 | example 2 | example 3 |
| Hardness | 73 | 75 | 77 | 72 | 73 |
| Tension rupture strength¹⁾ | 27.5 | 26.3 | 26.2 | 20.1 | 20.5 |
| Tension rupture elongation²⁾ | 390 | 378 | 305 | 259 | 272 |

¹⁾Unit: Mpa
²⁾Unit: %

As seen from Tables 3 and 4, Examples 1 to 8 using as the raw rubber the carboxylated acrylonitrile-butadiene rubber are more excellent in the tension rupture strength and equivalent to or more in the hardness and the tension rupture elongation in comparison with Comparative examples 1 to 3 using the not carboxylated and ordinary acrylonitrile-butadiene rubber.

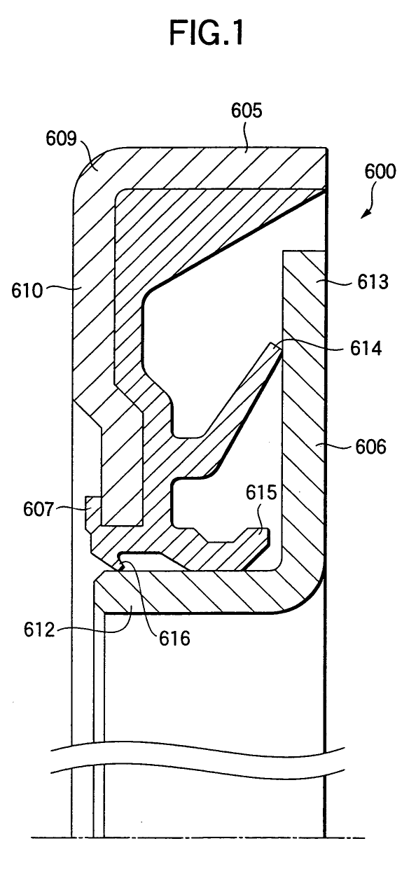

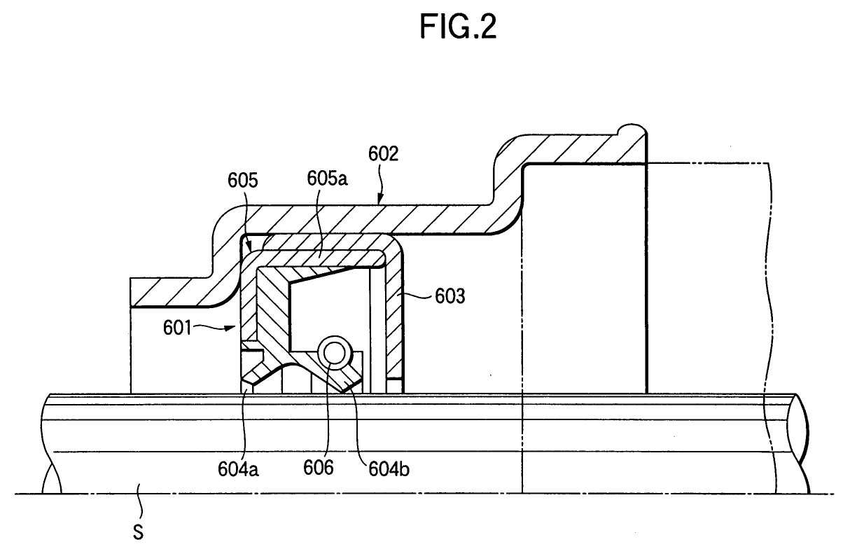

By use of the rubber material compositions of Examples 1 to 8 and Comparative examples 1 to 3, the hub unit seals 600 as shown in FIG. 1 were made (the elastic material 607 of the hub unit seal 600 was composed of said rubber material composition).

The structure of the hub unit seal 600 will be explained.

The hub unit seal 600 is composed of a core metal 605, a slinger 606 and an elastic member 607. of them, the core metal 605 is unified as one body by carrying out the stamping and the plastic working such as pressing on a metal sheet of a low carbon steel sheet. The core metal 605 has an outer diameter-side cylinder part 609 and an inner side circular part 610, and is circular of almost L shape in cross section, said outer diameter-side cylinder part 605 being freely secured to an inner periphery of the end part of an outer wheel composing a rolling bearing (not shown), and said inner side circular part 610 being bent inwardly in a diameter direction from an inner edge in an axial direction (the left edge of FIG. 1) of the outer diameter-side cylinder part 605 .

The slinger 606 is unified as one body by carrying out the stamping and the plastic working such as pressing on a metal sheet having an excellent corrosion resistance as a stainless steel sheet. The slinger 606 has an inner diameter-side cylinder part 612 and an outer side circular part 613, and is circular of almost L shape in cross section, said inner diameter-side cylinder part 612 being freely secured to an outer periphery of the end part of an inner wheel composing said rolling bearing, and said outer side circular part 613 being bent outwardly in a diameter direction from an outer edge in an axial direction (the right edge of FIG. 1) of the inner diameter-side cylinder part 612.

The elastic member 607 is composed of the elastic rubber material composition having an outside, a middle, an inside sealing lips 614, 615, 616, and the base portion thereof is secured to the core metal 605.

The outermost side sealing lip 614 contacts at its front end an outside circular part 613 composing the slinger 606, while the middle sealing lip 615 and the inside sealing lip 616 contact at their front ends the outer periphery of the inner diameter-side cylinder 612 composing the slinger 606. Thereby, the grease is prevented from leakage from the inside, and at the same time, dusts, the water or a muddy water are avoided from invasion into the bearing from the outside.

Such a hub unit seal 600 was incorporated in a rotation tester of sole hub unit seal made Nippon Seiko Co., Ltd. for carrying out rotation tests as being exposed to a muddy water. The testing conditions are as follows.

Kind of the hub unit seal: Inner diameter of 60 mm

Rotation speed: 1000 rpm

Rotation time: 72 hrs

Eccentricity: 0.5 mm TIR

Exposing conditions to the muddy water: the muddy water of 2 liters per min was sprayed toward the hub unit seal by repeating a cycle of 10 second spray—20 second stop.

The results of the rotation test of the hub unit seal are shown in Tables 5 and 6. The abrasion amounts in Tables 5 and 6 are relative values when the abrasion amount of the hub unit seal (sealing lip) composed of the rubber material composition of Example 1 is 1. The sealing property was evaluated by the amount of the water content (after the test) contained in the grease coated on the hub unit seal. A case where the water content is 1% or less is good and shown with ◯, a case where the water content is 2 to 5% is somewhat bad and shown with Δ, and a case where the water content is 5% or more is poor and shown with X.

The temperature of the sealing lip of the hub unit seal at the driving side was measured in that a thermocouple was inserted into the interior of the sealing lip for measuring the temperature at a stable rotation after rotation for 24 hrs (unit: ° C.).

TABLE 5

| | Example 1 | Example 2 | Example 3 | Example 4 | Example 5 | Example 6 |
|---|---|---|---|---|---|---|
| Wearing amount | 1 | 0 | 3 | 3 | 1 | 3 |
| Sealing property | ◯ | ◯ | ◯ | ◯ | ◯ | ◯ |
| Temperature of seal lip | 62 | 65 | 42 | 68 | 72 | 48 |

TABLE 6

| | | | Comparative | Comparative | Comparative |
|---|---|---|---|---|---|
| | Example 7 | Example 8 | example 1 | example 2 | example 3 |
| Wearing amount | 3 | 3 | 22 | 45 | 47 |
| Scaling property | ◯ | ◯ | X | X | X |
| Temperature of seal lip | 55 | 56 | 72 | 82 | 68 |

As seen from Tables 5 and 6, Examples 1 to 8 using as the raw rubber the carboxylated acrylonitrile-butadiene rubber were less in the abrasion amount of the sealing lip in comparison with the hub unit seals composed of the rubber material compositions of Comparative examples 1 to 3 using the not carboxylated and ordinary acrylonitrile-butadiene rubber.

The hub unit seals employing the rubber material compositions of Examples 1 to 8 contained the very low water content, while the hub unit seals employing the rubber material compositions of Comparative examples 1 to 3 contained the much water content. Thus, the hub unit seals using the rubber material compositions of Examples 1 to 8 are also excellent in the sealing property.

Effects of the additives will be explained.

The hub unit seals employing the rubber material compositions of Examples 1, 2 and 5 containing the carboxyl modified polyethylene particles and the carboxyl modified polypropylene particles as the abrasion improving agent were improved in the abrasion resistance and the bending-fatigue resistance owing to working of the abrasion improving agent, and therefore the wearing amount of the sealing lip was lower in comparison with the hub unit seals using the rubber material compositions of other examples.

The hub unit seals using the rubber material compositions of Examples 3 and 6 containing a amino-modified silicone oil as the lubricant oil are improved in the lubricity of the rubber material composition owing to working of the lubricant oil, and therefore the heat is restrained and the temperature of the sealing lip is controlled to be low in comparison with the hub unit seals using the rubber material compositions of other examples.

As mentioned above, the rubber material composition of the present embodiment employs as the raw rubber the carboxylated acrylonitrile-butadiene rubber, and in addition to the ordinary cross-linking by the vulcanizing agent, the cross-linking progresses also in the part of the carboxyl group existing in the molecular structure. Thus, the cross-linking density of rubber is heightened, and the tensile strength, the abrasion resistance and the bending-fatigue resistance are improved.

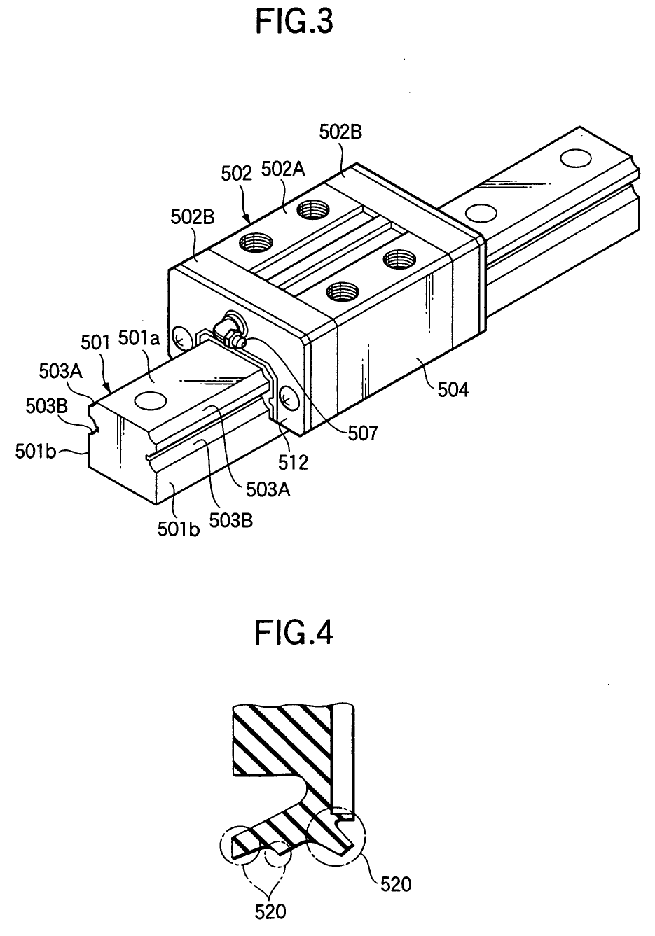

Under shown is an example of the rolling device furnished with the sealing member composed of the rubber material composition of this embodiment. At first, the linear guide apparatus is explained, referring to FIG. 3.

A slider 502 substantially rectangular in transversely cross section is mounted over a square guide rail 501 relatively movable in the axial direction. The slider 502 comprises a slider main body 502A and end caps 502B detachably attached at both ends in the axial direction thereof. At a ridge part crossing an upper surface 501a of the guide rail 501 and both side faces 501b, one-sided grooves 503A for rolling elements are formed in the axial direction, which comprise concave grooves of substantial ¼ are in cross section, while at middle parts of both side faces 501b of the guide rail 501, the other-sided grooves 503B for rolling elements are formed in the axial direction, which are semi-circular in cross section.

On the other hand, at inside corners of both sleeves 504 of the slider main body 502A, grooves for rolling element (not shown) of almost semi-circular cross section are formed in opposition to the one-sided grooves 503A for rolling elements, while at the center of both sleeves 504, grooves for rolling elements (not shown) of almost semi-circular cross section are formed in opposition to the other-sided grooves 503B for rolling elements.

The grooves 503A, 503B for rolling elements of the guide rail 501 and the two grooves for rolling elements of both sleeves 504 form paths (not shown) for rolling elements. These two rolling element-paths are linear and almost circular in cross section.

The slider 502 further has return paths (not shown) for rolling elements comprising two pass holes circular in cross section passing in the axial direction at the upper and lower parts of thick parts in the sleeve 504 of the slider main body 502A.

The end caps 502B have curved paths (not shown) for communicating the rolling element-paths with the rolling element-return paths parallel therewith. These rolling element-paths, rolling element-return paths and curved paths at both ends form circulating paths of the rolling elements into which lots of rolling elements (not shown) made of, e.g., steel balls are rotatably charged.

The slider 502 mounted on the guide rail 501 smoothly moves along the guide rail 501 via rolling of the rolling elements within the rolling element-paths, and during moving, the rolling elements circulate indefinitely as rolling in the circulation paths.

The slider 502 is furnished with contact sealing members 512 at both ends thereof (at more outsides of the end caps 502B) for dust-sealing clearances formed between the slider and the guide rail 501. The contact sealing member 512 is the sealing member formed in that the rubber material composition and the core metal (reinforcing member) of SECC material (zinc plated steel sheet) of a rectangle agreeing to the outer shape of the end cap 502B are integrally formed by a vulcanization attaching.

At least portions of the contact sealing members 512 sliding on the guide rail 501 are composed of the rubber material composition such that the portions are formed to slide on the upper surface 501a and both side faces 501b of the guide rail 501 to meet the cross sectional shape of the guide rail 501 for sealing the clearance between the slider 502 and the guide rail 501. For exactly sealing the clearance, the dimension of the inner side is somewhat smaller (around 0.1 to 0.2 mm) than a dimension contacting the surface of the guide rail 501. The core metal is non-contacted to the guide rail 501.

A part (the lip part) of the inside rubber of the contact sealing member 512 sliding on the guiding rail 501 is, as shown in FIG. 4, formed with three convexs 520, and the excellent sealing property is realized by these convexs 520. This convex portion is not limited to three pieces but may be one, two or four pieces or more.

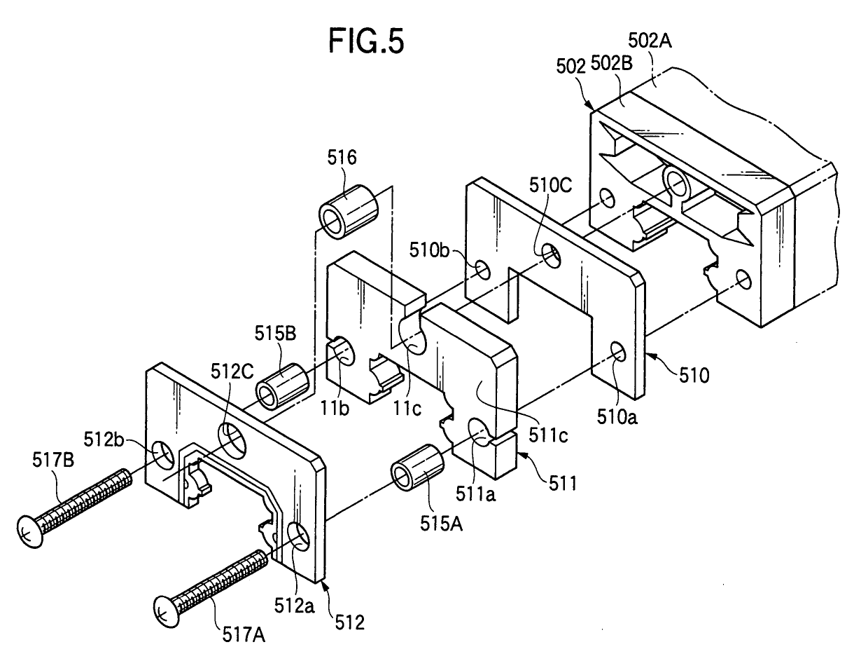

Now, explanation will be made to another example of the linear guide apparatus furnished with the sealing member composed of the rubber material composition of this embodiment, referring to FIG. 5. The linear guide apparatus of FIG. 5 is almost the same structure as above mentioned in FIG. 3, and so only different points will be discussed, omitting as to the similar parts. In FIG. 5, the same or corresponding parts of FIG. 3 will be given the same numerals and signs.

At the more outside of the end cap 502B secured to both edges in the axial direction of the slider main body 502A of the slider 502, in order from the side nearer the end cap 502B, there are secured as piled a reinforcing plate 510, a lubricant supply member 511 composed of the lubricant containing polymer and the contact sealing member 512. Among them, the contact sealing member 512 has the same structure as that of the contact sealing member 512 of the linear guide apparatus of FIG. 3.

The reinforcing sheet 510 is a steel sheet of almost rectangle meeting the outer shape of the end cap 502B. This reinforcing sheet 510 is non-contacted to the guide rail 501. The lubricant supply member 511 kept between the contact sealing member 512 and the reinforcing sheet 510 is also, as shown in the perspective view of FIG. 5, a substantially rectangular member meeting the outer shape of the end cap 502B, and the inside of the rectangle is, similarly to the inside of the contact sealing member 512, non-contacted to the upper surface 501a and both side faces 501b of the guide rail 501, agreeing to the cross section of the guide rail 501, otherwise contacted with at least one part thereof (the clearance between the lubricant supply member 511 and the guide rail 501 is 0 to 0.2 mm).

The composition of the lubricant containing polymer is the ultra high molecular polyethylene of 10 wt % (the ultra high molecular weight), the high density polyethylene of 20 wt % (the relatively low molecular weight), and the paraffin based mineral oil of 70 wt %. The lubricant supply member 511 is produced by injecting the lubricant containing polymer. No structure nor forming method of the lubricant containing polymer are especially limited, and as required, appropriate modifications are available.

The lubricant supply member 511 is formed with passing holes 511a, 511b for passing fixture screws when securing to the slider main body 502A and a passing hole 511c for fixing a grease nipple 507, and the passing holes 511a, 511b, 511c are inserted with pipe-like sleeves 515A, 515B, 516, and the grease nipple 507 passes through the sleeve 516. The length of these sleeves 515A, 515B, 516 is equal to the thickness of the lubricant supply member 511, or more or less longer (to around 0.2 mm).

The outer diameters of the sleeves 515A, 515B are larger than diameters of the passing holes 512a, 512b of the contact sealing member 512 and the passing holes 510a, 510b of the reinforcing sheet 510. In such a mariner, when tightening the lubricant supply member 511 between the contact sealing member 512 and tho reinforcing sheet 510 by means of fixture screws 517A, 517B, the pressure is not effected to the lubricant supply member 511, so that the self-shrinkage of the lubricant supply member 511 is not disturbed.

These contact sealing member 512, lubricant supply member 511 and reinforcing sheet 510 are, as shown in the perspective view of FIG. 5 showing the set-up conditions, screwed together with the end cap 502B to the slider main body 502A by passing the fixture screws 517A, 517B through the screw passing holes 512a, 512b of the contact sealing member 512, the screw passing holes 511a, 511b of the lubricant supply member 511 and the screw passing holes 510a, 510b of the reinforcing sheet 510. By the way, reference numeral 512c designates the passing hole for fixing the grease nipple 507 formed in the contact sealing member 512, and 510c is the passing hole for fixing the grease nipple formed in the reinforcing sheet 510.

In the linear guide apparatus having such a structure, the contact sealing member 512 seals the opposing clearance between the guide rail 501 and the slider 502, and so far as causing no abrasion in the contact sealing member 512, the water or dusts can be perfectly prevented from invasion before and after the slider 502.

When the linear guide apparatus is driven, the lubricant supply member 511 also moves non-contacting or contacting the guide rail 501, and the lubricant gradually exudes from the lubricant supply member 511 as a time passes, but since the lubricant supply member 511 is disposed nearly the lip part of the contact sealing member 512 (that is, the inside face of the contact sealing member 512 contacting the guide rail 501), the lubrication at the lip part of the contact sealing member 512 is kept stable for a long period owing to the exuding lubricant.

A mode of the lubricant supply member 511 contacting the guide rail 501 can supply the lubricant to the lip part of the contact sealing member 512 through the surface of the guide rail 501, and therefore, the lubricant is especially stably supplied to the lip part. Thus, since the lip part of the contact sealing member 512 is least worn, the sealing property by the contact sealing member 512 is maintained for a long period, and foreigners are avoided from invasion into the slider main body 502A, so that the linear guide apparatus itself is effected with a long life.

Besides, the lubricant from the lubricant supply member 511 is automatically supplied via in particular the rolling element-grooves 503A, 503B to the rolling elements running in the rolling element-grooves 503A, 503B. Owing to this self-lubricity, the stable and smooth action is carried out for a long period. Accordingly, although not supplying. the lubricant to the slider 502 from the outside, a good driving can be continued at low torque.

Further, in the mode of the lubricant supply member 511 contacting the guide rail 501, since the lubricant supply member 511 itself self-shrinks as the lubricant is exuded from the lubricant supply member 511, the lubricant supply member 511 closely contacts the surface to be sealed of the guide rail 501 by this shrinking force, and the sealing function and the lubricating function are accomplished.

In addition, since the lubricant supply member 511 is disposed between the end cap 502B and the contact sealing member 512 via the reinforcing sheet 510, the lip part of the contact sealing member 512 is difficult to turn up in spite of reciprocation of the slider 502, and the lubricant within the slider 502 is checked to leak outside.

Being such a structure, the fixture hole of the grease nipple 507 may be closed with a blind plug, but if required, it is sufficient that this is opened to supply the lubricant as the grease into the slider 502.

In this linear guide apparatus, the lubricant supply member 511 is fixed to the edge of the end cap 502B under the condition where it is held between the reinforcing sheet 510 and the contact sealing member 512, but no limitation is made to this structure only For example, the contact sealing member 512 is directly attached to the edge of the end cap 502B, while the lubricant supply member 511 held between two reinforcing sheets 510 may be secured to the edge of the end cap 502B attached with the contact sealing member 512. Even in such a structure, as far as the lubricant supply member 511 is disposed nearly the lip part of the contact sealing member 512, the same effect as mentioned above is displayed.

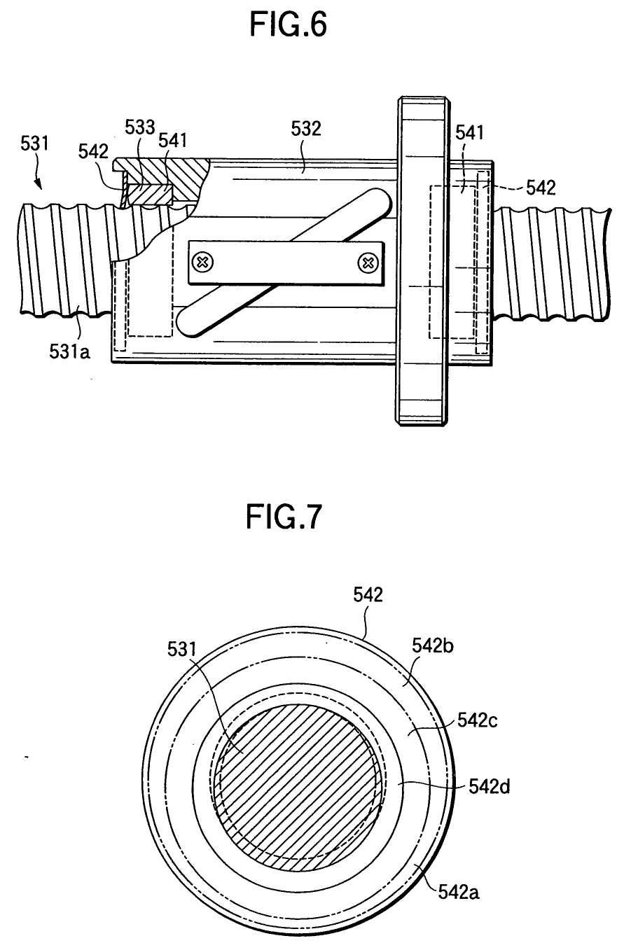

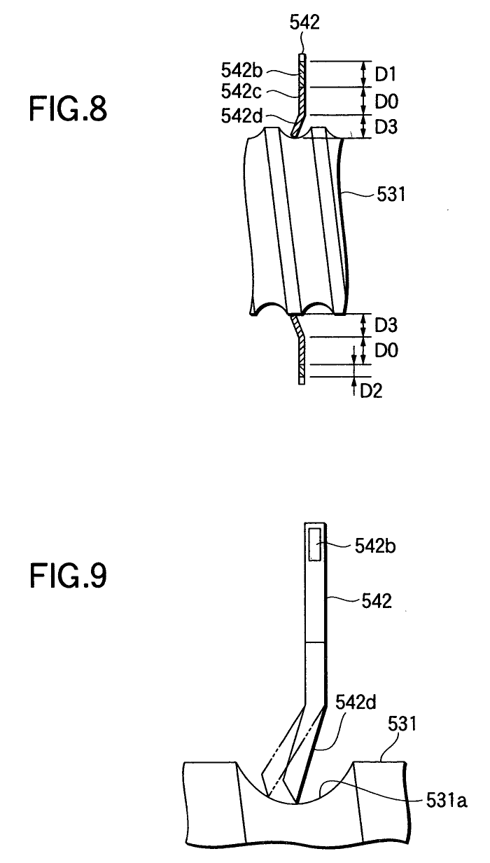

Further explanation will be made to the ball screw having the sealing member composed of the rubber material composition of this embodiment, referring to the drawings. FIG. 6 is a side view, partially in section, showing the structure of the embodied ball screw. FIG. 7 is a front view of the ball screw of FIG. 6, and FIG. 8 is a view showing contacting parts of a thread groove 531a of the ball screw 531 of FIG. 6 and the contact sealing member 542.

The ball screw comprises a screw shaft 531 having a spiral thread 531a being are in cross section on the outer circumference, a cylindrical ball screw nut 532 having an inside thread to be screwed on the screw shaft 531 in opposition to the thread 531a of the shaft 531, and a plurality of balls (not shown) charged in spiral ball rolling space being substantially circular in cross section and defined with the thread 531a of the shaft 531 and the thread of the ball screw nut 532.

The ball screw nut 532 is inserted at the insides of both edges in the axial direction with the cylindrical lubricant supply members 41, 41 of the lubricant containing polymer, and the inner diameter face of the lubricant supply member 541 contacts only the outer diameter face of the screw shaft 531 and is non-contacted to the thread 531a. The lubricant supply member 541 is composed of two semi-cylindrical members, and has a narrow groove on the outer circumference. The lubricant supply member 541 is urged at constant pressure in the radial direction toward the outer circumference of the screw shaft 531 by a garter spring 533 provided there. Therefore, even if the inner periphery of the lubricant supply member 541 is worn owing to working for a long period, a proper contact with the screw shaft 531 is kept, and a preferable lubrication is maintained.

The composition of the lubricant containing polymer composing the lubricant supply member 541 is the same as that of the lubricant supply member 511 in the linear guide apparatus (FIG. 5), but no limitation is made thereto and appropriate alternation is possible.

The outside in the axial direction of the lubricant supply member 541 is urged with the contact sealing members 542, 542. The contact sealing member 542 is the sealing member composed of a cora metal (reinforcing member) 542b made of metal or plastic, a disc shaped seal main body 542c wrapping the core metal 542b, and a seal piece 542d of substantial cone (oblique in the left side in the respective drawings) extending inwardly from the seal main body 542c.

The seal piece 542d is provided at the center with an opening 542a in response to the cross section of the screw shaft 531 having a smaller inner diameter than it. A ball screw nut 532 (not shown in FIG. 7) is unified as one body with the seal main body 542c securing the outer periphery and a seal piece 542d by use of the rubber material composition. The part of the rubber material composition and the core metal 542b are unified by the vulcanizing adherence.

The core metal 542b is circular in the outer periphery, but the inner periphery has a similar figure to the opening 542a, that is, as shown in FIG. 8, a lower width D2 is smaller than an upper width D1. Accordingly, it is possible that a distance DO between the inner periphery of the core metal 542b and the inner periphery of the seal main body 542c is fixed to a distance D3 between the inner periphery of the seal main body 542c and the inner periphery of the seal main body 542c all over the periphery. Thereby, a bending amount of the contact sealing member 542 can be made almost fixed when contacting to the screw shaft 531.

FIG. 9 is an enlarged view showing a state of the contact sealing member 542 contacting the screw shaft 531. The contact sealing member 542 shown with a solid line contacts the screw shaft 531, while the contact sealing member 542 shown with a two-dotted line contacts the screw shaft 531 and is deformed. The contacting part (lip part) of the sealing piece 542d to the screw shaft 531 is always a tightening margin to the outer diameter face of the screw shaft 531 and the thread 531a (actually, the clearance is kept 0 (zero) or less by the deformation).

As is seen from FIG. 9, when the contact sealing member 542 contacts any part (the outer diameter face or the thread 531a of the screw shaft 531) of the screw shaft 531, the bending direction of the sealing piece 542d can be predicted. Thus, it is possible to design the shape of the sealing piece 542d so that the sealing property is maximum thereby. Incidentally no limitation is made to the structure and shapes of the contact sealing member 42 of the present embodiment.

When the ball screw nut 532 moves, the contact sealing member 542 slides on the screw shaft 531, thereby to exactly seal the interior, prevent invasion of foreigners as the water or dusts into the space between the screw shaft 531 and the ball screw nut 532, and avoid the lubricant from leaking outside of the ball screw nut 532. Therefore, the life of the ball screw is lengthened. In addition, the contact sealing member 542 is supplied with the lubricant exuded from the lubricant supply member 541, and so the lip part is difficult to cause abrasion so that the sealing property is excellent.

The present embodiment has referred to the rolling bearing as the rolling device, exemplifying the linear guide apparatus and the ball screw, and the rubber material composition of the invention may be applied to many other rolling device s and the invention is not limited to the present embodiment.

The embodiment of the linear guide apparatus according to the invention will be explained with reference to the attached drawings.

[First Embodiment]

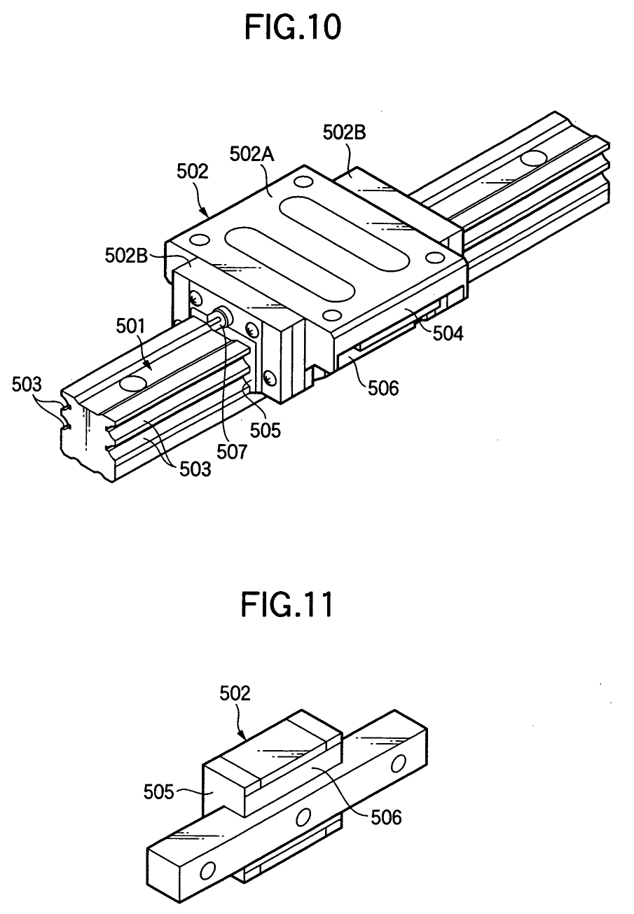

FIG. 3 is the perspective view showing the structure of the linear guide apparatus as the first embodiment of the linear guide apparatus according to the invention. In FIG. 3, the same or corresponding parts as those shown in the drawings for explaining the conventional examples (FIGS. 10 and 11) will be given the same numerals and signs.

A slider 502 substantially rectangular in transversely cross section is mounted over a square guide rail 501 relatively movable in the axial direction. The slider 502 comprises a slider main body 502A and end caps 502B detachably attached at both ends in the axial direction thereof. At a ridge part crossing an upper surface 501a of the guide rail 501 and both side faces 501b, one-sided grooves 503A for rolling elements are formed in the axial direction, which comprise concave grooves of substantial ¼ are in cross section, while at middle parts of both side faces 501b of the guide rail 501, the other-sided grooves 503B for rolling elements are formed in the axial direction, which are semi-circular in cross section.

On the other hand, at inside corners of both sleeves 504 of the slider main body 502A, grooves for rolling element (not shown) of almost semi-circular cross section are formed in opposition to the one-sided grooves 503A for rolling elements, while at the center of both sleeves 504, grooves for rolling elements (not shown) of almost semi-circular cross section are formed in opposition to the other-sided grooves 503B for rolling elements.

The grooves 503A, 503B for rolling elements of the guide rail 501 and the two grooves for rolling elements of both sleeves 504 form paths (not shown) for rolling elements. These two rolling element-paths are linear and almost circular in cross section.

The slider 502 further has return paths (not shown) for rolling elements comprising two pass holes circular in cross section passing in the axial direction at the upper and lower parts of thick parts in the sleeve 504 of the slider main body 502A.

The end caps 502B have curved paths (not shown) for communicating the rolling element-paths with the rolling element-return paths parallel therewith. These rolling element-paths, rolling element-return paths and curved paths at both ends form circulating paths of the rolling elements into which lots of rolling elements (not shown) made of, e.g., steel balls are rotatably charged.

The slider 502 mounted on the guide rail 501 smoothly moves along the guide rail 501 via rolling of the rolling elements within the rolling element-paths, and during moving, the rolling elements circulate indefinitely as rolling in the circulation paths.

The slider 502 is furnished with contact sealing members 512 at both ends thereof (at more outsides of the end caps 502B) for dust-sealing clearances formed between the slider and the guide rail 501. The contact sealing member 512 is integrally formed by the vulcanizing adherence with the rubber material composition (a detailed structure will be mentioned later) having the raw rubber and polyolefin based resin, and the core metal (reinforcing member) of SECC material (zinc plated steel sheet) of a rectangle agreeing to the outer shape of the end cap 502B.

At least portions of the contact sealing members 512 sliding on the guide rail 501 are composed of the rubber material composition such that the portions are formed to slide on the upper surface 501a and both side faces 501b of the guide rail 501 to meet the cross sectional shape of the guide rail 501 for sealing the clearance between the slider 502 and the guide rail 501. For exactly sealing the clearance, the dimension of the inner side is somewhat smaller (around 0.3 to 0.4 mm) than a dimension contacting the surface of the guide rail 501. The core metal is non-contacted to the guide rail 501.

A part (the lip part) of the inside rubber of the contact sealing member 512 sliding on the guiding rail 501 is, as shown in FIG. 4, formed with three convexs 520, and the excellent sealing property is realized by these convexs 520. This convex portion is not limited to three pieces but may be one, two or four pieces or more. The rubber material composition was produced in that the raw rubber, the polyolefin based resins and several kinds of the additives were mixed as the ratio shown in Table 11, and passed through the respective steps as shown under.

TABLE 11

| | | | | | Comparative | Comparative |
|---|---|---|---|---|---|---|
| | Example 1 | Example 2 | Example 3 | Example 4 | example 1 | example 2 |
| law rubber A | 100 | 100 | 100 | 100 | 100 | |
| Raw rubber B | | | | | | 100 |
| Polyolefin rosin A | 20 | | | | | |
| Polyolefin resin B | | 20 | | 20 | | |
| Polyolefin resin C | | | 20 | | | |
| Abrasion improving | | | | 10 | | |
| agent | | | | | | |
| Reinforcing agent | SO | 50 | 50 | 50 | 50 | 50 |
| Coupling agent | 2 | 2 | 2 | 2 | 2 | 2 |
| Cross-linking | 3 | 3 | 3 | | 3 | |
| agent | | | | | | |
| Vulcanizing agent | | | | 0.5 | | 0.5 |
| Vulcanization | | | | 0.8 | | 0.8 |
| accelerator A | | | | | | |
| vulcanization | | | | 1.5 | | 1.5 |
| accelerator B | | | | | | |
| Vulcanization | | | | 1 | | 1 |
| accelerator C | | | | | | |
| Vulcanization | 1 | 1 | 1 | 1 | 1 | i |
| accelerating | | | | | | |
| assistant A | | | | | | |
| Vulcanization | S | 5 | 5 | 5 | 5 | S |
| accelerating | | | | | | |
| assistant B | | | | | | |
| Vulcanization | 2 | 2 | 2 | 2 | 2 | 2 |
| accelerating | | | | | | |
| assistant C | | | | | | |
| Plasticizer | 5 | 5 | 5 | 5 | 5 | 5 |
| Age resister A | 1 | 1 | 1 | 1 | 1 | 1 |
| Age resister B | 1 | 1 | 1 | 1 | 1 | 1 |

Unit: parts by weight

The respective kinds of the used materials (described in Table 11) will be explained.

Raw rubber A: carboxylated middle high nitrile rubber (Nipol DN631 made by Nippon Zeon Co., Ltd.)

Raw rubber B: middle high nitrile rubber (JSR NBR N230S made by JSR Co., Ltd.)

Polyolefin based resin A; ultra high molecular poly ethylene (Miberon XM220 made by Mitsui Chemical Co., Ltd.)

Polyolefin based resin B: carboxyl modified poly ethylene (Modic-AP H501 made by Mitsubishi Chemicals Co., Ltd.)

Polyolefin based resin C: carboxyl modified poly propylene (Modic-AP H502 made by Mitsubishi Chemicals Co., Ltd.)

Abrasion improving agent: carnauba wax

Reinforcing material: hydrated silica (Nip Seal AQ made by Nippon Silica Industries Co., Ltd.)

Coupling agent: γ-mercaptopropyltrimethoxysilane KBM803 made by Shinetsu Silicone Co., Ltd.)

Cross-linking agent: Dikumilperoxide (Perkmil D made by Nippon Fats acrylonitrile-butadiene rubber Oils Co., Ltd.)

Vulcanizing agent; high dispersing sulfur (Sulfax PMC made by Tsurumi Industries Co., Ltd.)

Vulcanization accelerator A: tetramethylthiuramdi sulfide (Accel TMT made by Kawaguchi Chemical Industries Co., Ltd.)

Vulcanization accelerator C: tetraethylthiuramdi sulfide (KOCCELLER TET made by Ohuchi Shinko Chemical Industries Co., Ltd.)

Vulcanization accelerator C: N-cyclohexyl-2-benzo thiazil.sulfenamido (Accel CZ-R made by Kawaguchi Chemical Industries Co., Ltd.)

Vulcanization accelerating assistant A (serving also the lubricant): stearic acid (Luna c S-35 made by Kao Co. Ltd.)

Vulcanization accelerating assistant B: zinc oxide (France No. 1 made by Sakai Chemical Co., Ltd.)

Vulcanization accelerating assistant C (serving also the activator): Organic amine ((Acting SL made by Yoshitomi Seiyaku Co., Ld.)

Plasticizer: dioctyl phthalate (DOP made by Daihachi Chemicals Co., Ltd.)

Age resister A: 4,4′-bis (α, α-dimethylbenzil) diphenylamine (NOCRAC CD made by Ohuchi Shinko Chemical Industries Co., Ltd.)

Age resister B: 2-mercaptobenzimidazole NOCRAC MB made by Ohuchi Shinko Chemical Industries Co., Ltd.)

Next, reference will be made to the respective steps producing the contact sealing members 512.

(1) First Mastication Step

Materials other than the cross-linking agents and the vulcanization accelerators of Table 1 were charged into a banbury mixer, and kneaded at 80° C.

(2) Kneading Step

The masticated material was take out from tho banbury mixer, and charged into a rubber kneading two-roll. As controlling the roll temperature at 50° C., the vulcanization accelerators of Table 1 (or the cross-linking agent) were charged and the operation was repeated until becoming uniform, followed by forming a sheet shape.

(3) Vulcanizing Step and Vulcanization Adhering Step

A hot press heated at 170° C. was attached with a sheet vulcanizing mold for making 2mm thickness on which the sheet obtained in the kneading step was mounted. The sheet was heated and pressed for 15 minutes, and the vulcanized rubber sheets of 150 mm×150 mm×2 mm were produced.

The contact sealing member 512 was produced by integrally vulcanization-adhering the above mentioned rubber sheet to SECC made core metal (substantially rectangular having three fixture screw holes) previously baked with the adhesive in the metal mold of an objective shape.

Examples 1 to 3 and Comparative example 1 employing the peroxide based cross-linking agent were further heated at 150° C. for 2 hours to carrying out the second vulcanization.

As to the thus produced rubber material compositions (Examples 1 to 4 and Comparative examples 1 and 2), the measured results of the properties of matter are shown in Table 12.

TABLE 12

| | | | | | Comparative | Comparative |
|---|---|---|---|---|---|---|
| | Example 1 | Example 2 | Example 3 | Example 4 | example 1 | example 2 |
| Hardness HD_{A} | 80 | 82 | 82 | 81 | 78 | 78 |
| Tension rupture | 24.5 | 26.9 | 26. 5 | 26.1 | 24.0 | 14.0 |
| elongation (MPa) | | | | | | |
| Tension rupture | 215 | 228 | 234 | 225 | 208 | 409 |
| elongation (%) | | | | | | |
| Worn depth (μm) | 4 | 2 | 2 | 1.5 | 10 | 180 |

As seen from Table 12, the rubber material compositions of Examples 1 to 4 have the small worn depth in comparison with the rubber material composition not added with polyolefin based resin.

When employing the carboxyl modified polyolefin based resin (Examples 2 to 4), it is seen that the worn depth is further smaller, the abrasion resistance is improved, and the tension rupture strength is also heightened in comparison with the case of using the polyolefin based resin not carboxyl modified Example 1).

When using, as the raw rubber, nitrile rubber non modified (not carboxylated) (Comparative example 2), the corrosion resistance (the worn depth) is by far inferior and the tension rupture strength is also remarkably lowered in comparison with the case where carboxylated acrylonitrile-butadiene rubber is used to the raw rubber (others than Comparative example 2).

The methods measuring the respective properties of matter are as follows.

(a) Hardness Test

The sheet obtained in the vulcanizing step was stamped into shape of JIS No.3 test piece, and piled in three sheets for measuring hardness (spring hardness A scale) based on JIS K6301.

(b) Tensile Test

JIS No.3 test piece was performed with the tensile test by means of a universal tester for measuring the ruptured tension strength and the tension rupture elongation.

(c) Friction wearing test

In accordance with the friction wearing test A method of JIS K7218 plastic sliding, the test was performed. The friction wearing tester was EFM-III-E (made by TOYOBALDWIN Co., Ltd.)

The wearing depth was calculated by measuring surface conditions of the test piece before and after test by use of Surfcom (Tokyo SEIMITSU Co., Ltd.). The testing conditions are as follows.

Sliding speed: 1100 mm/sec

sliding distance: 20 km

Load: 9.8 N

Surface pressure; 4.9 N/cm²

Testing temperature; Room temperature

Opposite material: SUJ2

Surface roughness of the opposite material: 0.4 Ra

Hardness of the opposite material: HRC55 to 62

The results of the travelling tests by the linear guide apparatus will be explained. The contact sealing members 512 unified as one body with the rubber material compositions of Examples 1 to 4 and Comparative examples 1 and 2 and the core metals were attached by one sheet to both edges of the sliders 502 (LH 30 mm, height 45 mm, width 60 mm, length 85.6 mm and rail width 28 mm) of the linear guide apparatus of the first embodiment, and the travelling tests were performed under conditions.

Lubrication: No lubrication

Feed speed: Average 32 m/min

Stroke: 800 mm

Testing temperature: 40° C. (atmosphere)

Pre-load: 0

Travelling distance: 10 km

Space between the rubber lip part of the contact sealing device 512 and the guide rail 501: Minus space (interference) 0.35 mm

The wearing amounts of the rubber lip parts (the sliding parts) of the contact sealing members 512 after travelling are shown in Table 13.

TABLE 13

| | | | | | Comparative | Comparative |
|---|---|---|---|---|---|---|
| | Example 1 | Example 2 | Example 3 | Example 4 | example 1 | example 2 |
| Amount of wearing seal | 0.001 | 0 | 0 | 0 | 0.003 | 0.006 |
| (cm³) | | | | | | |

The results of Table 13 are in response to the results of the worn depths of Table 2. Examples 2 to 4 employing carboxyl modified polyolefin based resin are effected with no wearing after travelling 10 km, and it is seen that the bending-fatigue resistance is also superior in addition to the abrasion resistance. By the way, Comparative example 2 leaves almost no interference remaining because of wearing.

[Second Embodiment]

FIG. 5 is a perspective view showing attaching states of respective parts at edge parts of the linear guide apparatus as the second embodiment of the linear motion apparatus according to the invention. The linear guide apparatus of the second embodiment is almost the same structure, and so only different points will be discussed, omitting as to the similar parts. In FIG. 5, the same or corresponding parts of FIG. 3 will be given the same numerals and signs.

At the more outside of the end cap 502B secured to both edges in the axial direction of the slider main body 502A of the slider 502, in order from the side nearer the end cap 502B, there are secured as piled a reinforcing plate 510, a lubricant supply member 511 composed of the lubricant containing polymer and the contact sealing member 512.

Among them, the contact sealing member 512 has the same structure as that of the contact sealing member 512 of the linear guide apparatus of the first embodiment.

The reinforcing sheet 510 is a steel sheet of almost rectangle meeting the outer shape of the end cap 502B. This reinforcing sheet 510 is non-contacted to the guide rail 501. The lubricant supply member 511 kept between the contact sealing member 512 and the reinforcing sheet 510 is also, as shown in the perspective view of FIG. 5, a substantially rectangular member meeting the outer shape of the end cap 502B, and the inside of the rectangle is, similarly to the inside of the contact sealing member 512, non-contacted to the upper surface 501a and both side faces 501b of the guide rail 501, agreeing to the cross section of the guide rail 501, otherwise contacted with at least one part thereof (the clearance between the lubricant supply member 511 and the guide rail 501 is 0 to 0.2 mm).

The composition of the lubricant containing polymer is the ultra high molecular polyethylene of 10 wt % (the ultra high molecular weight), the high density polyethylene of 20wt % (the relatively low molecular weight), and the paraffin based mineral oil of 70 wt %. The lubricant supply member 511 is produced by injecting the lubricant containing polymer. No structure nor forming method of the lubricant containing polymer are especially limited, and as required, appropriate modifications are available.

The lubricant supply member 511 is formed with passing holes 511a, 511b for passing fixture screws when securing to the slider main body 502A and a passing hole 511c for fixing a grease nipple 507, and the passing holes 511a, 511b, 511c are inserted with pipe-like sleeves 515A, 515B, 516, and the grease nipple 507 passes through the sleeve 516. The length of these sleeves 515A, 515B, 516 is equal to the thickness of the lubricant supply member 511, or more or less longer (to around 0.2 mm).

The outer diameters of the sleeves 515A, 515B are larger than diameters of the passing holes 512a, 512b of the contact sealing member 512 and the passing holes 510a, 510b of the reinforcing sheet 510. In such a manner, when tightening the lubricant supply member 511 between the contact sealing member 512 and the reinforcing sheet 510 by means of fixture screws 517A, 517B, the pressure is not effected to the lubricant supply member 511, so that the self-shrinkage of the lubricant supply member 511 is not disturbed.

These contact sealing member 512, lubricant supply member 511 and reinforcing sheet 510 are, as shown in the perspective view of FIG. 5 showing the set-up conditions, screwed together with the end cap 502B to the slider main body 502A bypassing the fixture screws 517A, 517B through the screw passing holes 512a, 512b of the contact sealing member 512, the screw passing holes 511a, 511b of the lubricant supply member 511 and the screw passing holes 510a, 510b of the reinforcing sheet 510. By the way, reference numeral 512c designates the passing hole for fixing the grease nipple 507 formed in the contact sealing member 512, and 510c is the passing hole for fixing the grease nipple formed in the reinforcing sheet 510.

In the linear guide apparatus having such a structure, the contact sealing member 512 seals the opposing clearance between the guide rail 501 and the slider 502, and so far as causing no abrasion in the contact sealing member 512, the water or dusts can be perfectly prevented from invasion before and after the slider 502.

When the linear guide apparatus is driven, the lubricant supply member 511 also moves non-contacting or contacting the guide rail 501, and the lubricant gradually exudes from the lubricant supply member 511 as a time passes, but since the lubricant supply member 511 is disposed nearly the lip part of the contact sealing member 512 (that is, the inside face of the contact sealing member 512 contacting the guide rail 501), the lubrication at the lip part of the contact sealing member 512 is kept stable for a long period owing to the exuding lubricant.

A mode of the lubricant supply member 511 contacting the guide rail 501 can supply the lubricant to the lip part of the contact sealing member 512 through the surface of the guide rail 501, and therefore, the lubricant is especially stably supplied to the lip part. Thus, since the lip part of the contact sealing member 512 is least worn, the sealing property by the contact sealing member 512 is maintained for a long period, and foreigners are avoided from invasion into the slider main body 502A, so that the linear guide apparatus itself is effected with a long life.

Besides, the lubricant from the lubricant supply member 511 is automatically supplied via in particular the rolling element-grooves 503A, 503B to the rolling elements running in the rolling element-grooves 503A, 503B. Owing to this self-lubricity, the stable and smooth action is carried out for a long period. Accordingly, although not supplying the lubricant to the slider 502 from the outside, a good driving can be continued at low torque.

Further, in the mode of the lubricant supply member 511 contacting the guide rail 501, since the lubricant supply member 511 itself self-shrinks as the lubricant is exuded from the lubricant supply member 511, the lubricant supply member 511 closely contacts the surface to be sealed of the guide rail 501 by this shrinking force, and the sealing function and the lubricating function are accomplished.

In addition, since the lubricant supply member 511 is disposed between the end cap 502B and the contact sealing member 512 via the reinforcing sheet 510, the lip part of the contact sealing member 512 is difficult to turn up in spite of reciprocation of the slider 502, and the lubricant within the slider 502 is checked to leak outside.

Being such a structure as the second embodiment, the fixture hole of the grease nipple 507 may be closed with a blind plug, but if required, it is sufficient that this is opened to supply the lubricant as the grease into the slider 502.

In this linear guide apparatus of the second embodiment, the lubricant supply member 511 is fixed to the edge of the end cap 502B under the condition where it is held between the reinforcing sheet 510 and the contact sealing member 512, but no limitation is made to this structure only. For example, the contact sealing member 512 is directly attached to the edge of the end cap 502B, while the lubricant supply member 511 held between two reinforcing sheets 510 may be secured to the edge of the end cap 502B attached with the contact sealing member 512. Even in such a structure, as far as the lubricant supply member 511 is disposed nearly the lip part of the contact sealing member 512, the same effect as the second embodiment is displayed.

As to the linear guide apparatus, the same travelling tests as the first embodiment were carried out. The rubber material composition composing the contact sealing member 512 is the same rubber material compositions of Examples 1 to 4 and Comparative examples 1 and 2. The results of 10 km travelling are shown in Table 14.

TABLE 14

| Amount of | | | | | | |
|---|---|---|---|---|---|---|
| wearing | | | | | Comparative | Comparative |
| seal (cm³) | Example 1 | Example 2 | Example 3 | Example 4 | example 1 | example 2 |
| First | 0.001 | 0 | 0 | 0 | 0.003 | 0.006 |
| embodiment | | | | | | |
| Second | 0 | 0 | 0 | 0 | 0.002 | 0.005 |
| embodiment | | | | | | |

Since the linear guide apparatus of the second embodiment is furnished with the rubber material composition 511, the lubricant is supplied to the lip part of the contact sealing member 512. As a result, the abrasion was reduced in comparison with the linear guide apparatus of the first embodiment.

[Third Embodiment]

FIG. 6 is a side view, partially in section, showing the structure of the ball screw of the third embodiment of the linear motion apparatus of the invention. FIG. 7 is a front view of the ball screw of FIG. 6. FIG. 8 is a view showing the contacting parts of the thread groove 531a of the screw shaft 531 in the ball screw in FIG. 6 and the contact sealing member 542.

The ball screw comprises a screw shaft 531 having a spiral thread 531a being are in cross section on the outer circumference, a cylindrical ball screw nut 532 having an inside thread to be screwed on the screw shaft 531 in opposition to the thread 531a of the shaft 531, and a plurality of balls (not shown) charged in spiral ball rolling space being substantially circular in cross section and defined with the thread 531a of the shaft 531 and the thread of the ball screw nut 532.

The ball screw nut 532 is inserted at the insides of both edges in the axial direction with the cylindrical lubricant supply members 41, 41 of the lubricant containing polymer, and the inner diameter face of the lubricant supply member 541 contacts only the outer diameter face of the screw shaft 531 and is non-contacted to the thread 531a. The lubricant supply member 541 is composed of two semi-cylindrical members, and has a narrow groove on the outer circumference, and by a garter spring 533 provided there, the lubricant supply member 541 is urged at constant pressure in the radial direction toward the outer circumference of the screw shaft 531. Therefore, even if the inner periphery of the lubricant supply member 541 is worn owing to working for a long period, a proper contact with the screw shaft 531 is kept, and a preferable lubrication is maintained.

The composition of the lubricant containing polymer composing the lubricant supply member 541 is the same as that of the lubricant supply member 511 in the second embodiment, but no limitation is made thereto and appropriate alternation is possible.

The outside in the axial direction of the lubricant supply member 541 is urged with the contact sealing members 542, 542. The contact sealing member 542 is the sealing member composed of a core metal (reinforcing member) 542b made of metal or plastic, a disc shaped seal main body 542c wrapping the core metal 542b, and a seal piece 542d of substantial cone (oblique in the left side in the respective drawings) extending inwardly from the seal main body 542c.

The seal piece 542d is provided at the center with an opening 542a in response to the cross section of the screw shaft 531 having a smaller inner diameter than it. A ball screw nut 532 (not shown in FIG. 7) is unified as one body with the seal main body 542c securing the outer periphery and a coal piece 542d by use of the rubber material composition of the first and second embodiments. The part of the rubber material composition and the core metal 542b are unified by the vulcanizing adherence. The rubber material composition is not limited to the rubber material compositions of the first and second embodiments, but as requested, appropriate alternation is available.

The core metal 542b is circular in the outer periphery, but the inner periphery has a similar figure to the opening 542a, that is, as shown in FIG. 8, a lower width D2 is smaller than an upper width D1. Accordingly, it is possible that a distance D0 between the inner periphery of the core metal 542b and the inner periphery of the seal main body 542c is fixed to a distance D3 between the inner periphery of the seal main body 542c and the inner periphery of the seal main body 542c all over the periphery. Thereby, a bending amount of the contact sealing member 542 can be made almost fixed when contacting to the screw shaft 531.

FIG. 9 is an enlarged view showing a state of the contact sealing member 542 contacting the screw shaft 531. The contact sealing member 542 shown with a solid line contacts the screw shaft 531, while the contact sealing member 542 shown with a two-dotted line contacts the screw shaft 531 and is deformed. The contacting part (lip part) of the sealing piece 542d to the screw shaft 531 is always a tightening margin to the outer diameter face of the screw shaft 531 and the thread 531a (actually, the clearance is kept 0 (zero) or less by the deformation).

As is seen from FIG. 9, when the contact sealing member 542 contacts any part (the outer diameter face or the thread 531a of the screw shaft 531) of the screw shaft 531, the bending direction of the sealing piece 542d can be predicted. Thus, it is possible to design the shape of the sealing piece 542d so that the sealing property is maximum thereby. Incidentally no limitation is made to the structure and shapes of the contact sealing member 42 of the third embodiment.

When the ball screw nut 532 moves, the contact sealing member 542 slides on the screw shaft 531, thereby to exactly seal the interior, prevent invasion of foreigners as the water or dusts into the space between the screw shaft 531 and the ball screw nut 532, and avoid the lubricant from leaking outside of the ball screw nut 532. Therefore, the life of the ball screw is lengthened. In addition, the contact sealing member 542 is supplied with the lubricant exuded from the lubricant supply member 541, and so the lip part is difficult to cause abrasion so that the sealing property is excellent.

The first, second and third embodiments have referred to the rolling bearing as the linear guide apparatus, exemplifying the linear guide apparatus and the ball screw, and the rubber material composition of the invention may be applied to many other rolling device s and the invention is not limited to the present embodiment.

As explained above, since the inventive rubber material composition has the carboxylated acrylonitrile-butadiene rubber, the cross-linking density is high, and as a result, the abrasion resistance and the bending-fatigue resistance are excellent. Further, the heat by friction is little.

Since the inventive rubber material composition has the carboxylated acrylonitrile-butadiene rubber and carbon black, the abrasion resistance is excellent and the heat by friction is little.

Accordingly, if the sealing member of the rolling device to be used with the grease lubrication under the hard circumstances allowing the water and dusts to much exist is fabricated with the invention rubber material composition, the excellent sealing property is maintained even under the severe environments, and a good life can be imparted to the rolling device.

As discussed above, the rubber material composition set forth in the first aspect of the invention is suitably used to the sealing members of the linear motion apparatus.

Further, the linear motion apparatus set forth in the fourth aspect of the invention is fabricated with the rubber material composition using as the raw rubber the carboxylated acrylonitrile-butadiene rubber, and is provided with the contact sealing members having lip parts excellent in the abrasion resistance and the bending- fatigue resistance, and therefore the lip part is difficult to cause abrasion with the excellent sealing property, and has a long life though being used under circumstances where foreigners as cut dusts are easy to go into.

What is claimed is:

1. A rubber material composition comprising:
carboxylated acrylonitrile-butadiene rubber.

2. The rubber material composition as set forth in claim 1, further comprising:
20 to 90 wt parts of carbon black for 100 wt parts of said carboxylated acrylonitrile-butadiene rubber.

3. The rubber material composition as set forth in claim 1, further comprising:
10 to 60 wt parts of polyolefin based resin for 100 wt parts of said carboxylated acrylonitrile-butadiene rubber.

4. A linear motion apparatus comprising:
an outer member;
an inner member disposed in opposite to the outer member via a clearance;
a plurality of rolling elements rotatably supported between said outer member and said inner member so as to move one of said outer and inner members relative to the other; and
a contact sealing member for sealing said clearance,
wherein said contact sealing member formed from a material containing said rubber material composition as set forth in claims 1 to 3 and a reinforcing member for the rubber material composition.

5. The linear motion apparatus as set forth in claim 4, wherein said outer member is a nut, and said inner member is a screw shaft.

6. The linear motion apparatus as set forth in claim 4, wherein said outer member is a slider, and said inner member is a guide rail.
